(19) United States
(12) Patent Application Publication
(10) Pub. No.: US 2024/0097859 A1
(43) Pub. Date: Mar. 21, 2024

(54) COMMUNICATION APPARATUS AND COMMUNICATION METHOD FOR MULTI-AP SYNCHRONOUS TRANSMISSION

(71) Applicant: Panasonic Intellectual Property Corporation of America, Torrance, CA (US)

(72) Inventors: Yanyi DING, Singapore (SG); Rojan CHITRAKAR, Singapore (SG); Hong Cheng, Michael SIM, Singapore (SG); Yoshio URABE, Nara (JP)

(21) Appl. No.: 18/263,057

(22) PCT Filed: Dec. 6, 2021
(86) PCT No.: PCT/SG2021/050756

§ 371 Date: Jul. 26, 2023

(30) Foreign Application Priority Data
Jan. 29, 2021 (SG) 10202101013V

(51) Int. Cl. H04L 5/00; H04L 1/1829; H04L 1/1867

(52) U.S. Cl. CPC H04L 5/0055; H04L 1/1864; H04L 1/188; H04L 1/1887

(57) ABSTRACT

Communication devices and methods for Multi-AP synchronous transmission are provided. One exemplary embodiment provides a communication apparatus comprising: circuitry, which in operation, generates a frame comprising information of a subsequent transmission; and a transmitter, which in operation, transmits the frame to another communication apparatus.

### BACKGROUND

### 1. Technical Field

The present embodiments generally relate to communication apparatuses, and more particularly relate to methods and apparatuses for multiple access point (Multi-AP) synchronous transmission.

### 2. Description of the Related Art

In the standardization of next generation wireless local area network (WLAN), a new radio access technology having backward compatibilities with IEEE 802.11a/b/g/n/ac/ax technologies has been discussed in the IEEE 802.11be Task Group.

In 11ax High Efficiency (HE) WLAN, multiple frame transmission in a transmission opportunity (TXOP) is supported enabling a station (STA) to transmit additional frames in a transmit queue. In 11be Extremely High Throughput (EHT) WLAN, in order to improve throughput over 1 lax HE WLAN, especially for cell-edge STAs, it has been proposed to enable coordinated orthogonal frequency-division multiple access (C-OFDMA) in a multi-AP system.

However, there has been no discussion so far concerning multiple frame transmission in a TXOP under C-OFDMA operation for Multi-AP synchronous transmission.

There is thus a need for communication apparatuses and methods that can solve the above mentioned issue. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for Multi-AP synchronous transmission.

According to an aspect of the present disclosure, there is provided a communication apparatus, comprising: circuitry, which in operation, generates a frame comprising information of a subsequent transmission; and a transmitter, which in operation, transmits the frame to another communication apparatus.

According to another aspect of the present disclosure, there is provided a communication method comprising: generating a frame comprising information of a subsequent transmission; and transmitting the frame to a communication apparatus

It should be noted that general or specific embodiments may be implemented as a system, a method, an integrated circuit, a computer program, a storage medium, or any selective combination thereof. Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

The accompanying figures where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1 illustrates an example of a single-AP based Multiple frame transmission in a TXOP in 11ax.

FIG. 2 illustrates an example of a failed transmission in which no block acknowledgement (BA or BlockAck) is received.

FIG. 3 illustrates an example of a failed transmission in which an invalid BA is received.

FIG. 4 illustrates an example of a BlockAck Req frame format in flax.

FIG. 5 illustrates an example table of BlockAck frame variants and their corresponding length (octets).

FIG. 6 illustrates an example of a typical C-OFDMA transmission.

FIG. 7 depicts a scenario of unaligned BlockAck frame.

FIG. 8 depicts a scenario of a failed data transmission.

FIG. 9 depicts a scenario of a failed BA transmission.

FIG. 10 illustrates C-OFDMA transmission according to an embodiment.

FIG. 11 illustrates an example of an asynchronous transmission.

FIG. 12 illustrates an example of a synchronous downlink (DL) transmission.

FIG. 13 illustrates an example of a synchronous uplink (UL) transmission.

FIG. 14 illustrates an example of a MAP Trigger frame.

FIG. 15 illustrates an example table of the MAP Trigger type and corresponding value.

FIG. 16 illustrates subfields of a UL TXVECTOR field in accordance with an embodiment.

FIG. 17 illustrates subfields of a UL TXVECTOR field in accordance with another embodiment.

FIG. 18 illustrates an example of a TRS Control subfield in accordance with an embodiment.

FIG. 19 illustrates an example table of default TXVECTOR parameters list in accordance with standard 802.11ax specifications.

FIG. 20 illustrates a new A-Control subfield of a HE variant HT Control field format.

FIG. 21 illustrates an example table of Control ID subfield values with their corresponding explanations.

FIG. 22 illustrates an example format of a MU-BAR Trigger frame in accordance with various embodiments.

FIG. 23 illustrates an example format of a new MAP-BAR Trigger frame in accordance with various embodiments.

FIG. 24 depicts an example table of Trigger Type encoding and corresponding trigger frame variant.

FIG. 25 illustrates an example of Common Information field of a MAP BAR Trigger frame format according to various embodiments.

FIG. 26 illustrates an example of Trigger Dependent User Info subfield of a MAP BAR Trigger frame format in accordance with various embodiments.

FIG. 27 illustrates an example flow diagram containing a ‘blank space’ in accordance with various embodiments.

FIG. 28 illustrates an example format of a new MAP Trigger frame requiring MAP response in accordance with various embodiments.

FIG. 29 illustrates a flow diagram of a single round of C-OFDMA transmission with MAP response in accordance with various embodiments.

FIG. 30 illustrates a flow diagram of a single round of C-OFDMA transmission with MAP response carried in a medium access control (MAC) frame in accordance with an embodiment.

FIG. 31 illustrates an example MAP Response frame format in accordance with various embodiments.

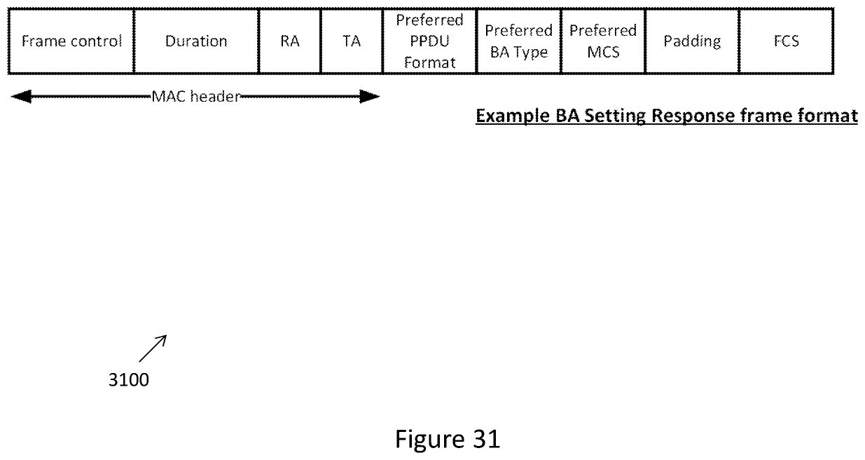

FIG. 32 illustrates a flow diagram of C-OFDMA transmission with MAP response carried in a null data packet (NDP) in accordance with an embodiment.

FIG. 33 illustrates an example format of a MAP Response NDP in accordance with an embodiment.

FIG. 34 depicts an example table of preferred PPDU format, corresponding resource unit (RU) tone set index values and feedback status for EHT-Long Training Field (EHT-LTF) Generation in MAP Response NDP.

FIG. 35 depicts an example table of preferred modulation and coding scheme (MCS), corresponding RU tone set index values and feedback status for EHT-Long Training Field (EHT-LTF) Generation in MAP Response NDP.

FIG. 36 depicts an example illustration of overlapping network ranges among APs and STAs.

FIG. 37 illustrates a flowchart for shared AP behaviour in accordance with various embodiments.

FIG. 38 illustrates a flow diagram for C-OFDMA error recovery using new C-OFDMA Error Recovery interval in accordance with various embodiments.

FIG. 39 illustrates a flow diagram for C-OFDMA error recovery using an extended interframe space (EIFS) in accordance with various embodiments.

FIG. 40 illustrates a flow diagram for C-OFDMA error recovery using transmission of short PPDUs in accordance with various embodiments.

FIG. 41 illustrates a flowchart for sharing AP behaviour in error recovery in accordance with various embodiments.

FIG. 42 illustrates a flow diagram for C-OFDMA Error Recovery in the case where MAP response is required and the expected ACK/BlockAck frame is received in accordance with various embodiments.

FIG. 43 illustrates a flow diagram for C-OFDMA Error Recovery in the case where MAP response is required and an expected ACK/BlockAck frame is not received during the AckTimeout interval in accordance with various embodiments.

FIG. 44 illustrates a flowchart for sharing AP behaviour in C-OFDMA error recovery in accordance with various embodiments.

FIG. 45 illustrates a flowchart for sharing AP behaviour in C-OFDMA error recovery mechanism including MAP Response in accordance with various embodiments.

FIG. 46 illustrates a configuration of a communication device, for example a communication apparatus, for example a Sharing AP, in accordance with various embodiments.

FIG. 47 shows a flow diagram illustrating a method for Multi-AP synchronous transmission according to various embodiments.

FIG. 48 shows a schematic, partially sectioned view of an AP or STA that can be implemented for Multi-AP synchronous transmission in accordance with various embodiments.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the embodiments or the application and uses of the embodiments. Furthermore, there is no intention to be bound by any theory presented in the preceding Background or this Detailed Description. Furthermore, other desirable features and characteristics will become apparent from the subsequent detailed description and the appended claims, taken in conjunction with the accompanying drawings and this background of the disclosure.

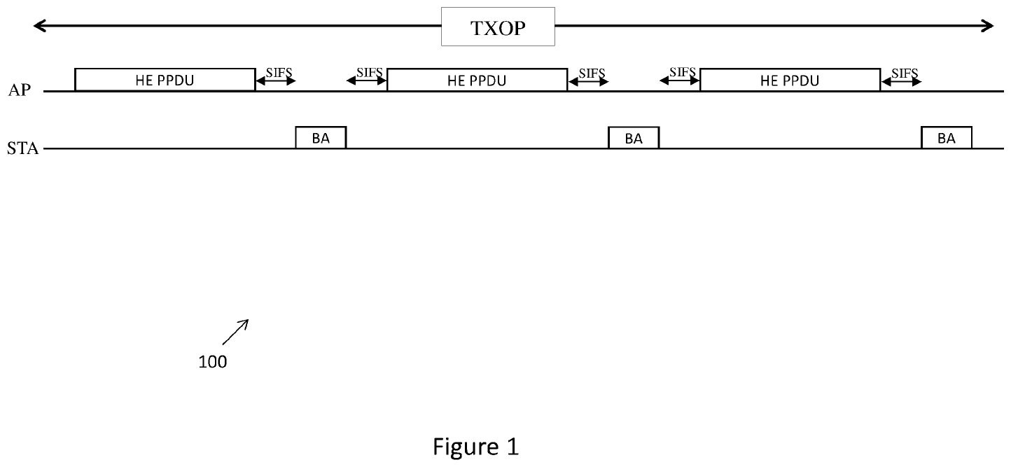

A TXOP is a bounded period during which a station may transfer data. Once a TXOP is obtained, the station may transmit data, control, and management frames and receive response frames, provided the frame sequence duration does not exceed the TXOP limit. An example of a single-AP based Multiple frame transmission in a TXOP in 11ax is illustrated in FIG. 1.

Multiple frame transmission within the TXOP occurs when an Enhanced Distributed Channel Access Function (EDCAF) retains the right to access the medium following the completion of a frame exchange sequence. If a TXOP holder has in transmit queue an additional frame and the duration of transmission of that frame plus any expected acknowledgment for that frame is likely to be finished in the TXOP, then the TXOP holder may commence transmission of that frame at a Short Interframe Space (SIFS) after the completion of the immediately preceding frame exchange sequence, subject to the TXOP limit restriction. If the transmission by the TXOP holder fails, the AP may invoke priority interframe space (PIFS) recovery.

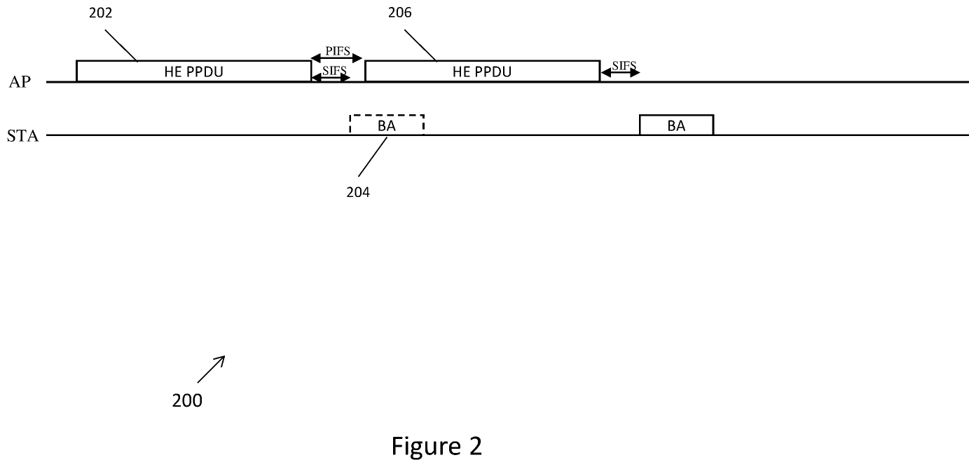

There are two cases in which the transmission is determined to be failed. In a first case, no block acknowledgement (BA or BlockAck) is received. Such an example is illustrated in FIG. 2. In a TXOP, a HE physical layer protocol data unit (PPDU) 202 containing a frame requiring immediate acknowledgement is sent by the AP. The beginning of reception of expected acknowledgement does not occur during the first slot time following a SIFS i.e. BA 204 is not received by the AP. The AP may then transmit another PPDU 206 containing a block acknowledgement request (BlockAckReq) frame at a PIFS after the previous frame.

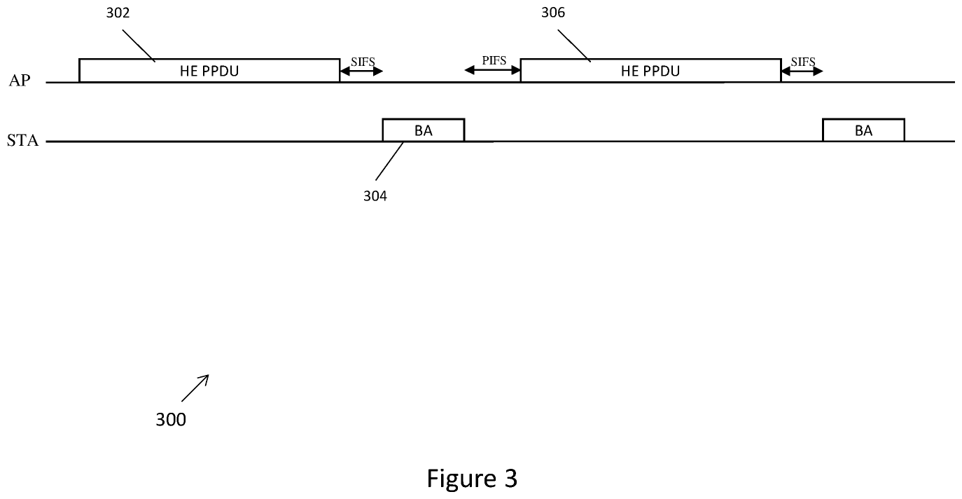

In a second case, an invalid BA is received. Such an example is illustrated in FIG. 3. In a TXOP, a HE PPDU 302 containing a frame requiring immediate acknowledgement is sent by the AP. Although the reception of expected acknowledgement does occur i.e. BA 304 is received by the AP, it is recognized as an invalid frame. The AP may then transmit another PPDU 306 containing BlockAckReq frame at a PIFS after the received BA frame.

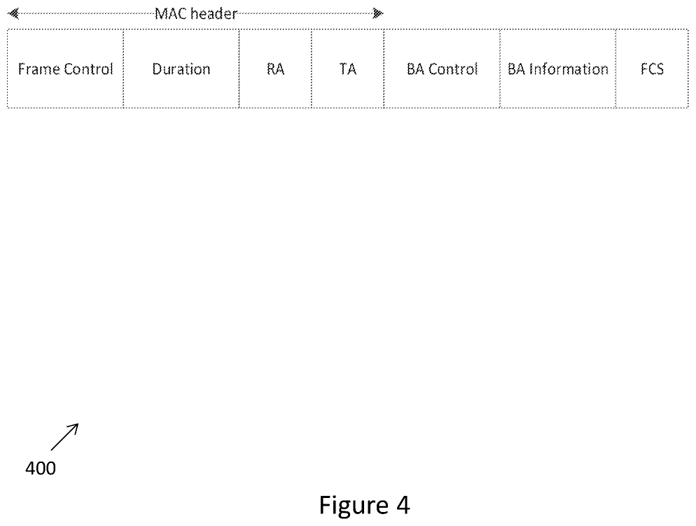

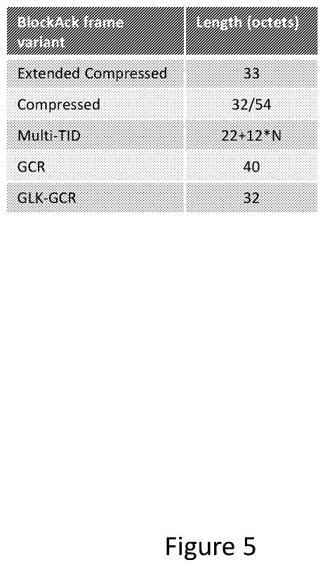

The length of PPDU carrying BlockAck frame depends on the BlockAck frame variants and the recipient device when solicited by a BlockAckReq frame. The BlockAck frame variant used is indicated in the BlockAckReq frame sent by STA soliciting immediate response. The type of PPDU used to carry the BlockAck frame is decided by the solicited STA, and may be a Non-HT PPDU or HE single user (SU) PPDU. Primary modulation and coding scheme (MCS) and primary rate is selected for the PPDU by the solicited STA. An example of a BlockAckReq frame format in flax is illustrated in FIG. 4, and an example table of the BlockAck frame variants and their corresponding length (octets) is illustrated in FIG. 5.

However, there is no information about parameters of uplink (UL) PPDU indicated in the BlockAckReq frame. The length of PPDU carrying BlockAck frame is decided by the STA when solicited by BlockAckReq frame. The AP may estimate but cannot decide the length of the PPDU.

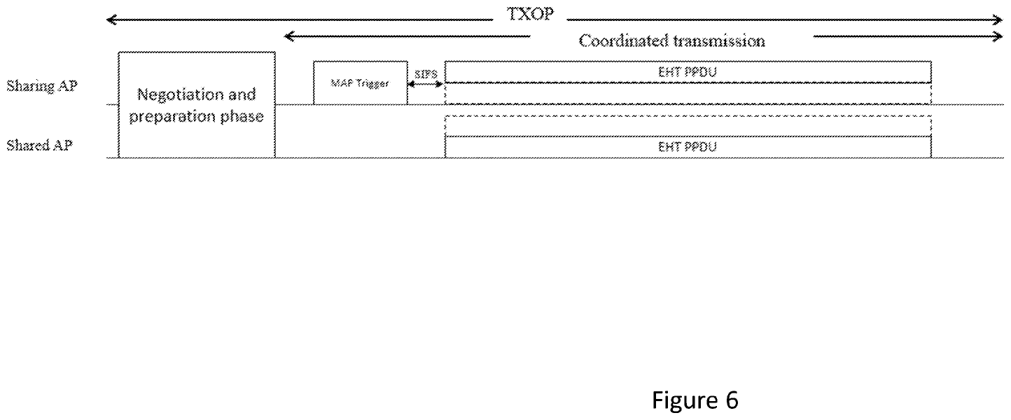

In C-OFDMA transmission, a Sharing AP shares frequency resources with Shared AP(s) during the obtained TXOP. An example of a typical C-OFDMA transmission is illustrated in FIG. 6. The Sharing AP shall share its frequency resource in multiples of 20 MHz channels with Shared AP(s). The C-OFDMA transmission may include two phases. In phase 1 (negotiation and preparation), necessary information may be exchanged for the C-OFDMA transmission. In phase 2, coordinated transmission among participating APs shall be initiated by the Sharing AP. If the coordinated transmission is synchronized, the necessary information for synchronization may be indicated prior to the coordinated transmission.

There may be lots of issues to realize multiple frame transmission in a TXOP of C-OFDMA operation. For example, ACI (Adjacent Channel Interference) and collision may be caused by unaligned BlockAck frame(s). In another example, there may be issues in error recovery wherein collision may be caused by unaligned BlockAck frame and 11ax error recovery mechanism.

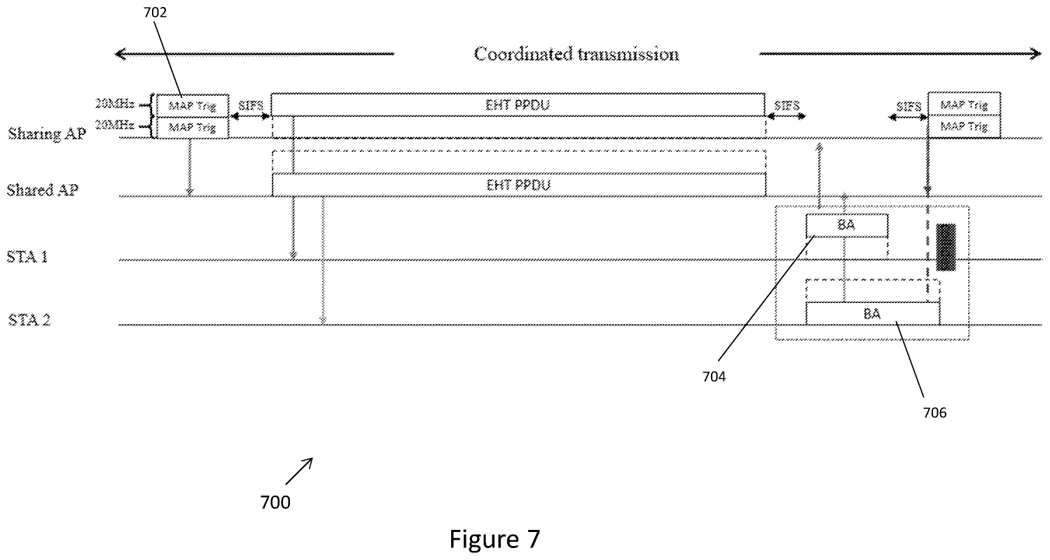

FIG. 7 illustrates a scenario of unaligned BlockAck frame. STA1 is associated with Sharing AP and STA2 is associated with Shared AP. Multi-AP (MAP) Trigger frame 702 is targeted at Shared AP and STA2 cannot hear Sharing AP. The BlockAck frame 704 transmitted by STA 1 and BlockAck frame 706 transmitted by STA 2 may be not aligned, thus collision and ACI (adjacent channel interference) may occur.

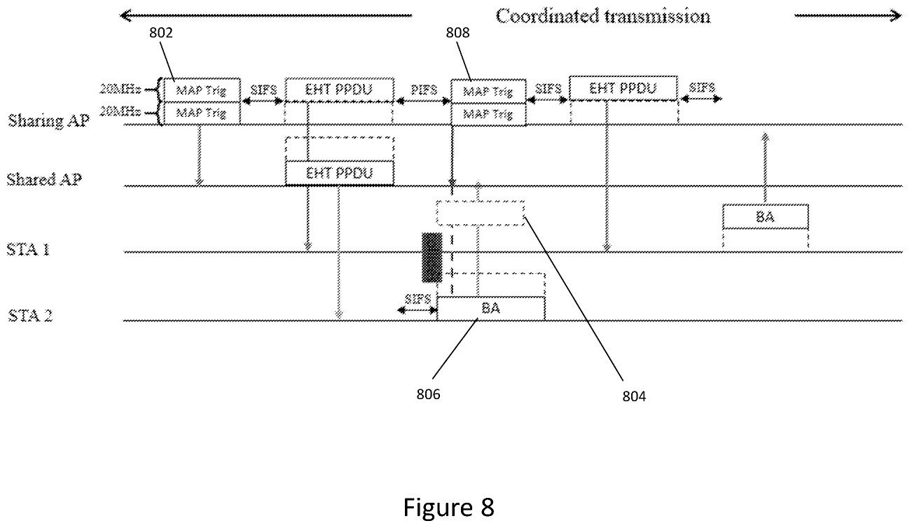

FIG. 8 illustrates a scenario of a failed data transmission. STA1 is associated with Sharing AP and STA2 is associated with Shared AP. MAP Trigger frame 802 is targeted at Shared AP and the Sharing AP cannot hear the STA2. If BlockAck frame 804 sent by STA1 is not received by the Sharing AP, PIFS recovery will be performed by Sharing AP. In this case, MAP Trigger frame 808 transmitted to Shared AP following the PIFS by Sharing AP will collide with BlockAck frame 806 transmitted by STA2.

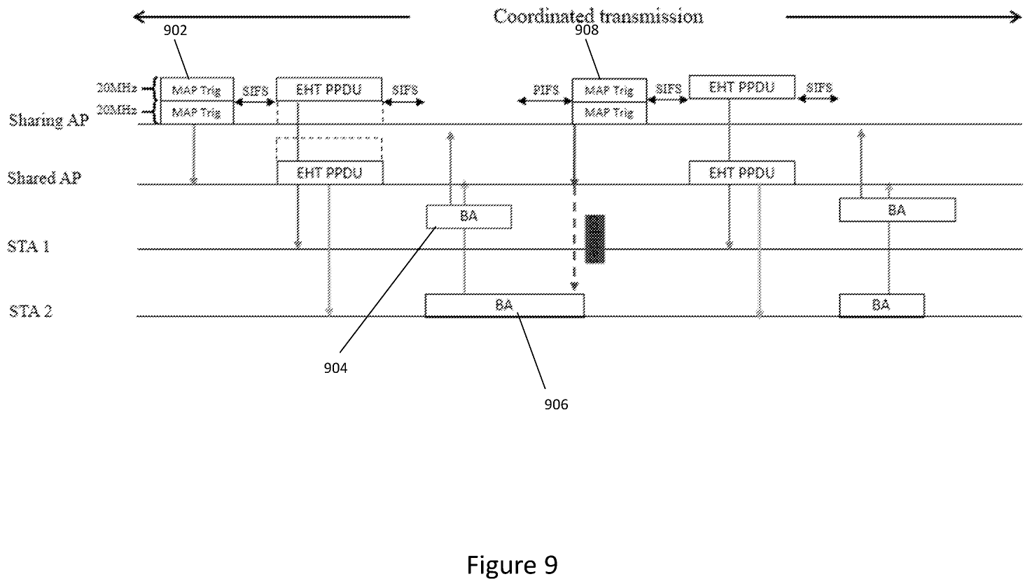

FIG. 9 illustrates a scenario of a failed BA transmission. STA1 is associated with Sharing AP and STA2 is associated with Shared AP. MAP Trigger frame 902 is targeted at Shared AP and the Sharing AP cannot hear the STA2. If BA frame 904 transmitted by STA1 fails, the Sharing AP transmits subsequent frame at a PIFS after the BA frame 904. It is possible for a transmission of a subsequent frame to collide with BlockAck frame 906 transmitted by STA2. However, if the BlockAck frames 904 and 906 transmitted by STA1 and STA2 are aligned, no such problem would occur.

In an operation in which multiple APs are transmitting together, one AP may send information about subsequent transmission to other AP(s). In a possible operation, Multi-AP Coordination or Multi-link transmission (when multi-link APs are involved) may be utilized such that information about subsequent transmission is shared among the APs, such as transmission type (async/sync), parameters of PPDU carrying the expected BlockAck frame, and other similar information.

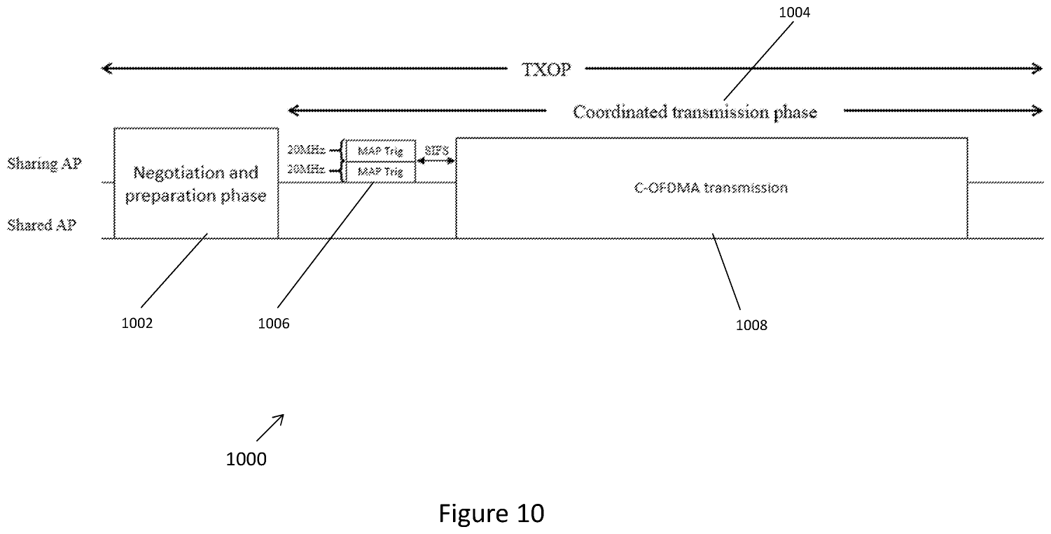

FIG. 10 illustrates C-OFDMA transmission according to an embodiment. The C-OFDMA transmission includes the following phases. In a negotiation and preparation phase 1002, the required negotiation and preparation for following coordinated transmission may be included. For example, exchange of request to send (RTS) and clear to send (CTS) frame, exchange of request and intent to join following coordinated transmission, the primary channel switch, the report of buffer status of candidate Shared AP(s), the selection of Shared AP(s), etc. Thereafter, a coordinated transmission phase 1004 may include one or more than one rounds of C-OFDMA transmission 1008. Sharing AP transmits a MAP Trigger frame 1006 to Shared AP(s) to initiate single round of C-OFDMA transmission. The MAP Trigger frame 1006 may be carried in non-HT duplicate PPDU. Further, the intended type of C-OFDMA transmission is indicated prior to the C-OFDMA transmission. In an option, the intended transmission type is indicated in the Negotiation and preparation phase 1002, such that the following coordinated transmission phase 1004 will include only one type of C-OFDMA transmission. In another option, the intended transmission type is indicated in the MAP Trigger frame 1006 for the initiated round of C-OFDMA transmission.

The intended type of C-OFDMA transmission may be an asynchronous transmission or a synchronous transmission. The intended type of transmission may be decided based on interference level, wherein the ACI between APs may be reduced by spectral mask in asynchronous transmission, and further reduced by aligned symbols in synchronous transmission. The intended type of transmission may also be decided based on buffer status of Shared AP(s), wherein asynchronous transmission is a better choice for scenarios where Shared AP(s) have large buffer. The intended type of transmission may also be decided based on duration of subsequent transmission of Sharing AP. For example, if the duration of subsequent transmission is long (i.e. till the end of the obtained TXOP), asynchronous transmission may be selected.

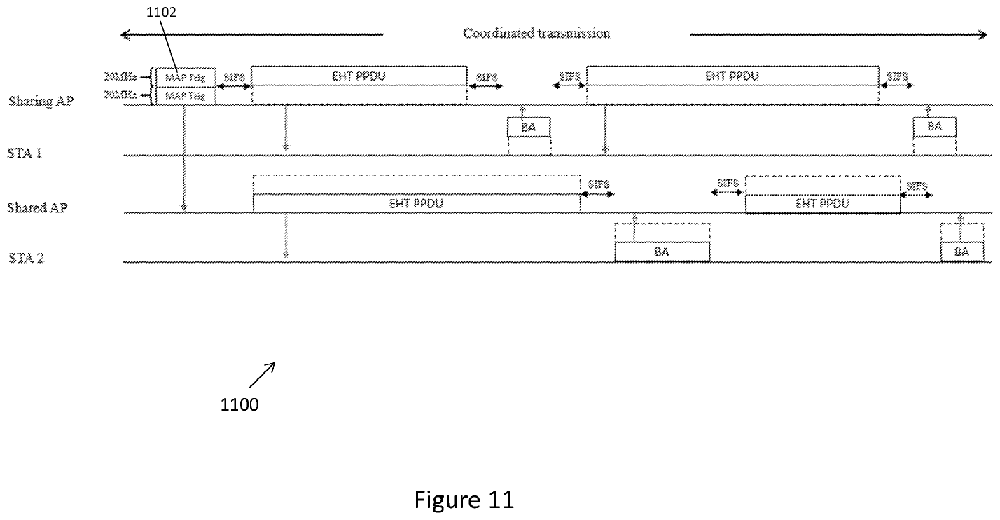

FIG. 11 illustrates an example of an asynchronous transmission. If asynchronous transmission is indicated, Sharing AP no longer controls the subchannel(s) allocated to the Shared AP(s) after transmission of MAP Trigger frame 1102. Instead, the Shared AP(s) gains total control of the allocated subchannel(s). Sharing AP and Shared AP(s) transmit on their own frequency resources independently. Thus, in an asynchronous transmission, the Sharing AP does not need to align the transmission but loses control on Shared AP(s) and allocated subchannels.

In the asynchronous transmission, the Sharing AP may still listen to the subchannels allocated to Shared APs if conditions permit, for example by using available antennas, or performing clear channel assessment (CCA) on subchannels during the SIFS between PPDUs. If the allocated subchannels are detected as idle for a long time (e.g. a PIFS, or idle during two successive times of SIFS), the Sharing AP may try transmitting a frame (e.g. Contention Free-End (CF-End) frame or MAP Trigger frame) to Shared AP(s) to terminate the coordinated transmission or take the allocated subchannels back for its own usage.

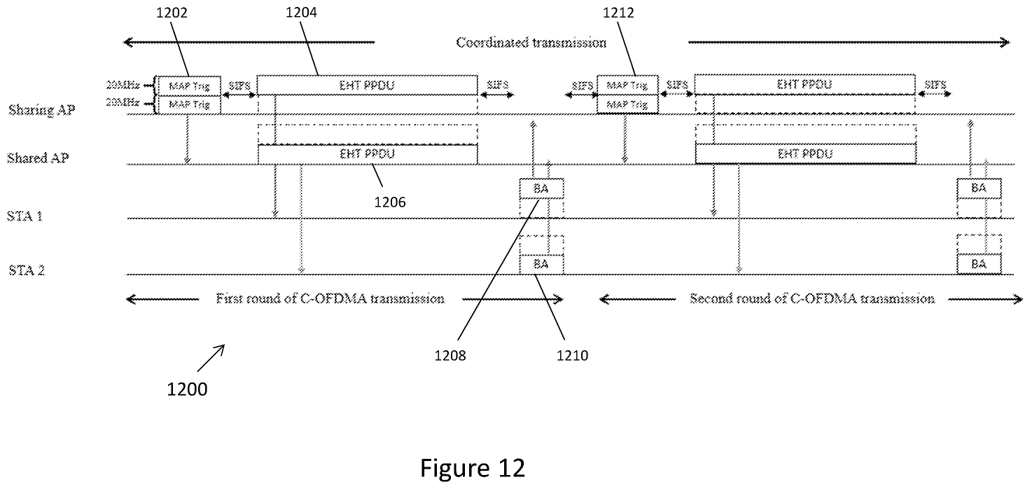

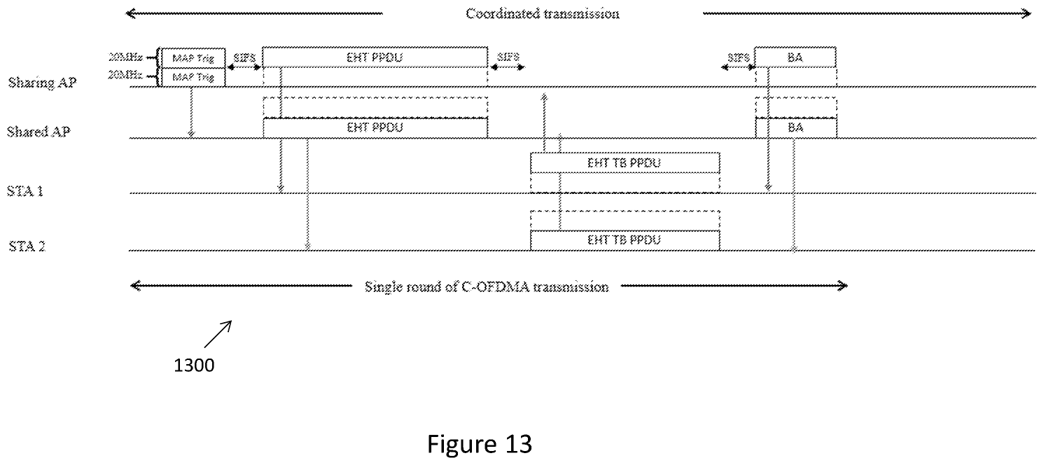

If synchronous transmission is indicated, Sharing AP controls all frequency resources till the end of the obtained TXOP. FIG. 12 illustrates an example of a synchronous downlink (DL) transmission, while FIG. 13 illustrates an example of a synchronous uplink (UL) transmission. For synchronous DL transmission as shown in FIG. 12, UL BlockAck frame in a following C-OFDMA transmission may be solicited by a Trigger frame 1202 or triggered response scheduling (TRS) Control field. Parameters needed for the following C-OFDMA transmission is indicated in MAP Trigger frame 1202, such as allocated frequency resources for each Shared AP, TXVECTORS needed to align C-OFDMA transmission, max transmit power, parameters of PPDU carrying BlockAck frame (e.g. PPDU Format), and other similar parameters.

After a SIFS, the Sharing AP and Shared AP(s) transmit data (in which the parameters of PPDU carrying BlockAck frame is contained) simultaneously on their own frequency resources subject to parameters indicated in the MAP Trigger frame 1202 (i.e. EHT PPDU 1204 transmitted from Sharing AP to STA1 and EHT PPDU 1206 transmitted from Shared AP to STA2). After a SIFS, STAs transmit BlockAck frame according to parameters carried in received DL PPDU simultaneously to corresponding associated AP (i.e. BA frame 1208 transmitted from STA1 to Sharing AP and BA frame 1210 transmitted from STA2 to Shared AP). If valid BlockAck frames are received, after at least a SIFS the Sharing AP may transmit a new MAP Trigger frame 1212 to initiate another round of C-OFDMA transmission if TXOP duration permits. If the Sharing AP does not receive the expected BlockAck frame, C-OFDMA recovery mechanism is performed. The Sharing AP may transmit a new MAP Trigger frame according to C-OFDMA recovery mechanism to initiate another round of C-OFDMA transmission if TXOP duration permits.

In synchronous transmission, Shared AP(s) shall not commence any transmission unless triggered or indicated by the Sharing AP. Further, the Shared AP(s) shall transmit subject to the parameters indicated in MAP Trigger frame. Advantageously, the BlockAck frames sent by STAs are aligned, and collision caused by misalignment of BlockAck frames or failed transmission of BlockAck frame is avoided.

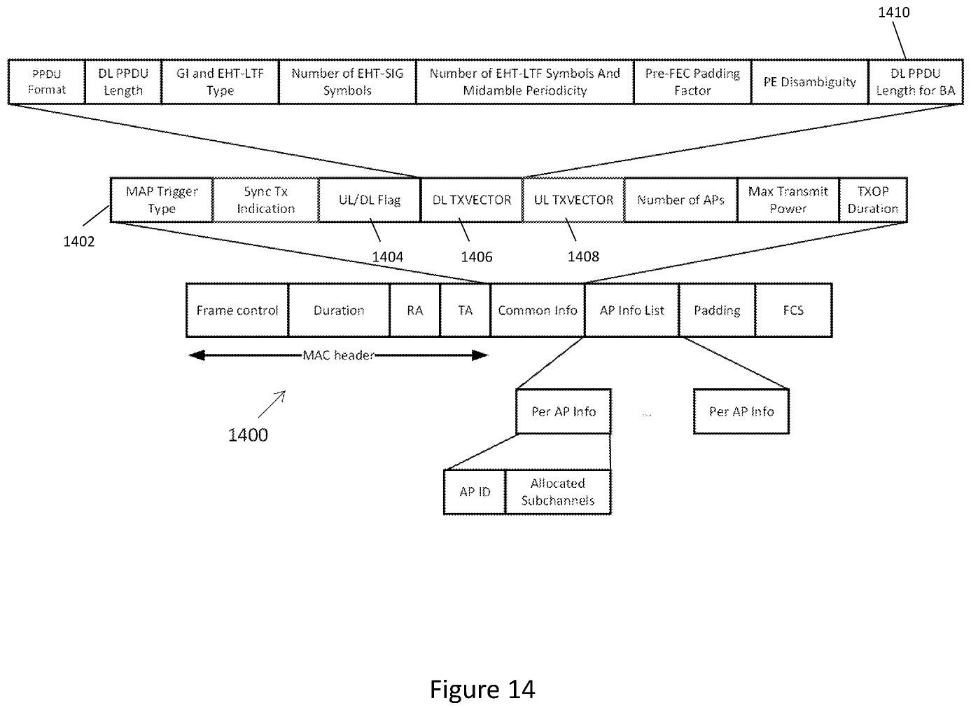

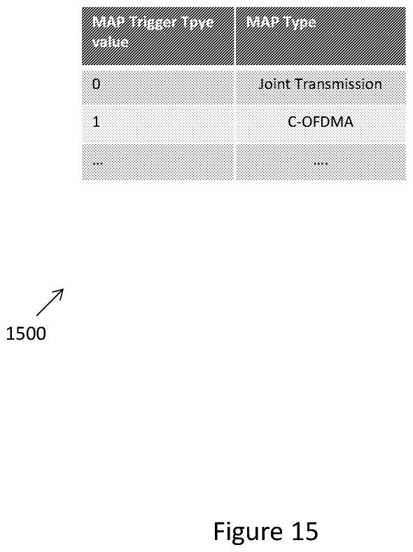

FIG. 14 illustrates an example of a MAP Trigger frame 1400, while FIG. 15 illustrates an example table of the MAP Trigger type and corresponding value. For example, when the MAP trigger type field 1402 indicates a value of ‘0’, the corresponding MAP type is joint transmission, and when the MAP trigger type field 1402 indicates a value of ‘1’, the corresponding MAP type is C-OFDMA transmission.

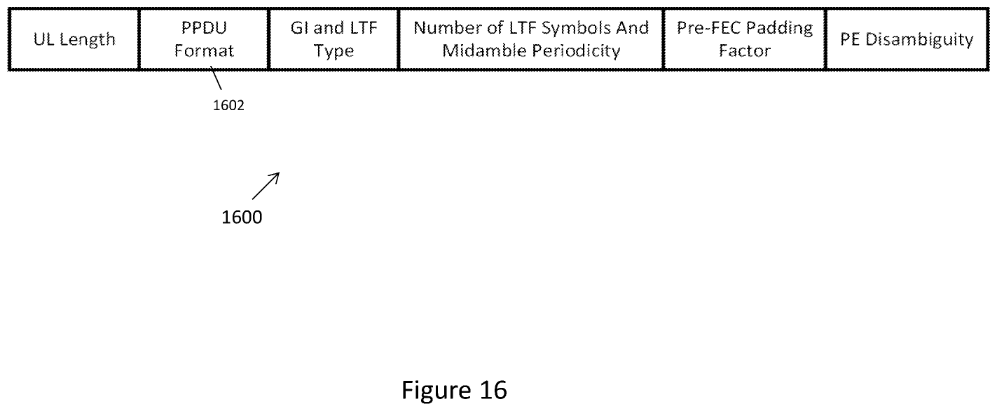

When UL/DL Flag field 1404 indicates ‘UL Transmission’, information contained in DL TXVECTOR field 1406 is used to indicate parameters for DL PPDU containing the Trigger frame and the parameters of DL PPDU carrying the BlockAck frame. Further, the information contained in UL TXVECTOR field 1408 is used to indicate parameters for Trigger-based UL PPDU which is going to be transmitted in following C-OFDMA transmission by STA(s). FIG. 16 illustrates subfields of UL TXVECTOR field 1408 when UL/DL Flag field 1404 indicates ‘UL Transmission’, wherein PPDU Format subfield 1602 may indicate HE TB PPDU/EHT TB PPDU.

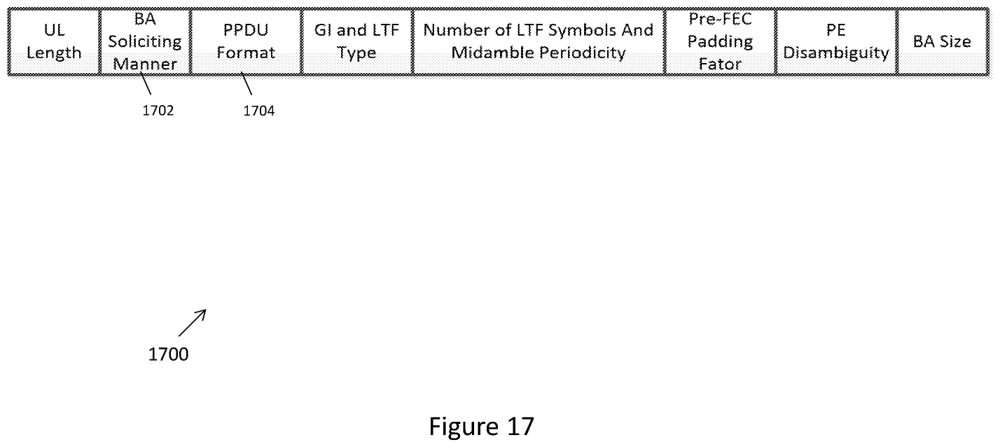

When UL/DL Flag field 1404 indicates ‘DL Transmission’, DL PPDU Length for BA subfield 1410 in DL TXVECTOR field 1406 is reserved, and information contained in UL TXVECTOR field 1408 is to indicate parameters of PPDU carrying BlockAck frames in following C-OFDMA transmission by STA(s). FIG. 17 illustrates subfields of UL TXVECTOR field 1408 when UL/DL Flag field 1404 indicates ‘DL Transmission’, wherein PPDU Format subfield 1704 may indicate Non-HT/HE/EHT PPDU. In an example, the PPDU format may be implicitly indicated i.e. the STA uses the same PPDU format as the soliciting DL PPDU to carry the BlockAck frame. BA Soliciting Manner subfield 1702 may indicate TRS Control field or Trigger frame/Trigger frame only. If the PPDU Format subfield 1704 is indicated as ‘Non-HT PPDU’ or BA Soliciting Manner subfield 1702 is indicated as ‘TRS Control field or Trigger frame’, subfields after PPDU Format subfield 1704 are reserved. The length of PPDU carrying the BlockAck frame is generally shorter than a normal data PPDU. The most significant bit (MSB) in UL TXVECTOR field 1700 may be reused to indicate BA Soliciting Manner, wherein number of UL data symbols may be indicated using less bits compared to indicating the length of UL PPDU.

In an embodiment, for each round of C-OFDMA transmission, the parameters of PPDU carrying the BlockAck frame indicated in the MAP Trigger frame sent by the Sharing AP are decided without explicit feedback from Shared AP(s). In one option, parameters are decided by Sharing AP based on its own requirement. In another option, parameters are decided based on a maximal length of bitmap in BlockAck frame by Sharing AP. The maximal length of bitmap could be either 1024 octets or the maximal capable bitmap length among all participated APs, which, may be exchanged in the Negotiation and preparation phase.

The Shared AP(s) prepare and transmit its DL transmission subject to parameters indicated in both DL TXVECTOR field and UL TXVECTOR field. The DL transmission contains information about parameters of PPDU carrying the BlockAck frame. If the BlockAck required by MAC protocol data units (MPDUs) or aggregated-MPDUs (A-MPDUs) in the transmit queue cannot be carried in the PPDU with indicated parameters, the Shared AP(s) may give up the MPDUs or shorten the A-MPDU. For example, the Sharing AP decides to solicit a PPDU with length L₁ to carry the BlockAck frame and indicates it to Shared AP. The Shared AP has an A-MPDU in which 180 MPDUs are carried in the transmit queue. The length of bitmap in the expected BlockAck frame should be 32 octets. The Shared AP calculates the expected length of PPDU carrying the expected BlockAck frame (L₂) based on parameters (length of BlockAck frame, highest MCS could use, PPDU format, etc), such that L₂>L₁. The Shared AP may then shorten the A-MPDU to 64 MPDUs inside and solicit BlockAck frame with 8 octets bitmap. This advantageously results in low complexity, but may cause large overhead or low throughput of Shared AP(s).

In an embodiment, when BA Soliciting Manner subfield in the MAP Trigger frame is indicated as ‘TRS Control field or Trigger frame’, the Sharing AP and Shared AP(s) may indicate parameters of PPDU carrying BlockAck frame by reusing the TRS Control subfield of the HE variant HT Control field to associated STAs. HT Control field is always present in a Control Wrapper frame and is present in Quality of Service (QoS) Data and Management frames when +HTC subfield of the Frame Control field is set as 1. The TRS Control subfield indicates partial parameters of PPDU carrying BlockAck frame. Other required parameters may be set as a default TXVECTOR parameters list. The PPDU shall carry a BlockAck Request frame with frame carrying the TRS Control subfield to indicate parameters of BlockAck frame.

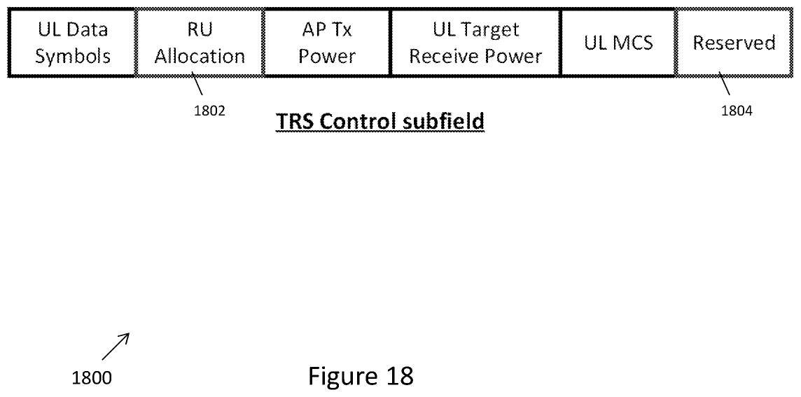

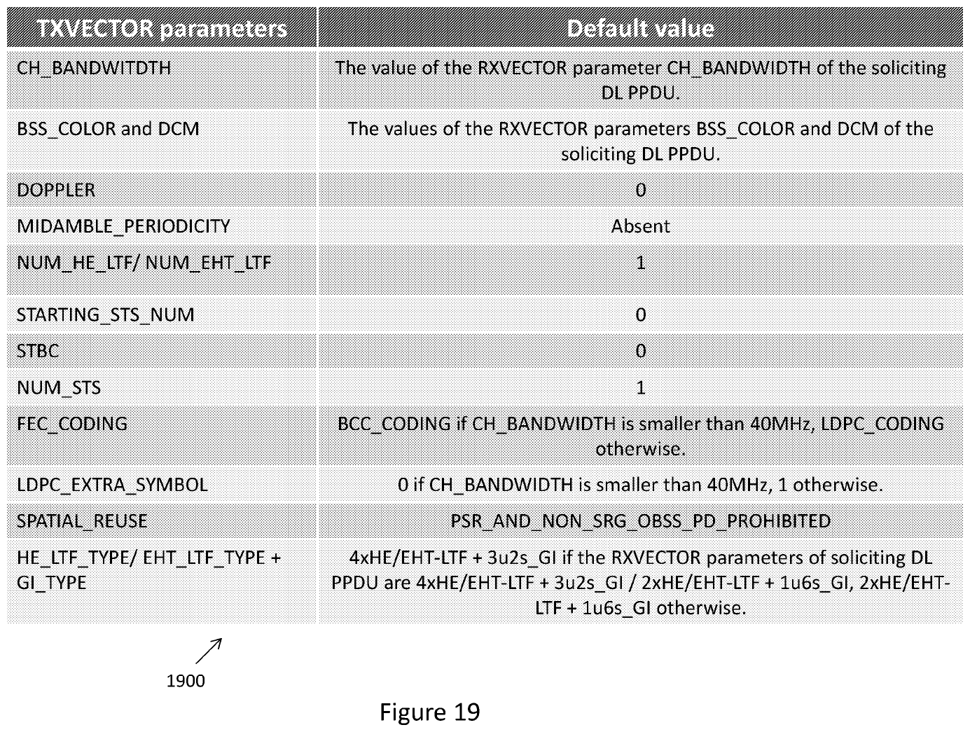

FIG. 18 illustrates an example of a TRS Control subfield 1800. In RU Allocation subfield 1802, reserved entries may be used to indicate PPDU Format when used to solicit PPDU carrying BA frame. The PPDU format may be a non-HT PPDU or EHT PPDU. Reserved subfield 1804 may be used to indicate that the TRS Control subfield 1800 is reused to indicate parameters of PPDU carrying BA frame. For example, when ‘0’ is indicated in the TRS Control subfield 1800, the PPDU format carrying the BA frame is HE TB PPDU. For further reference, FIG. 19 illustrates an example table of default TXVECTOR parameters list in accordance with standard 802.11ax specifications.

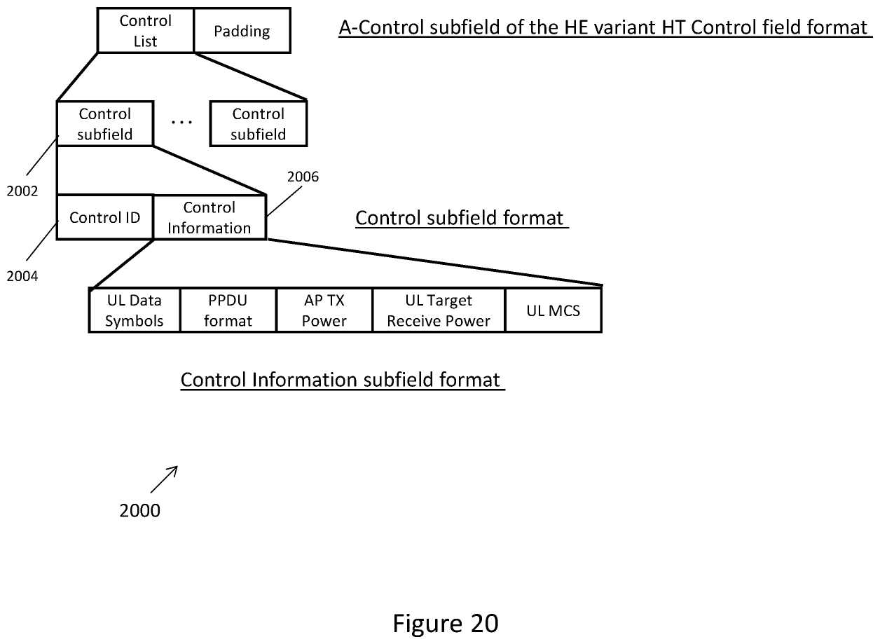

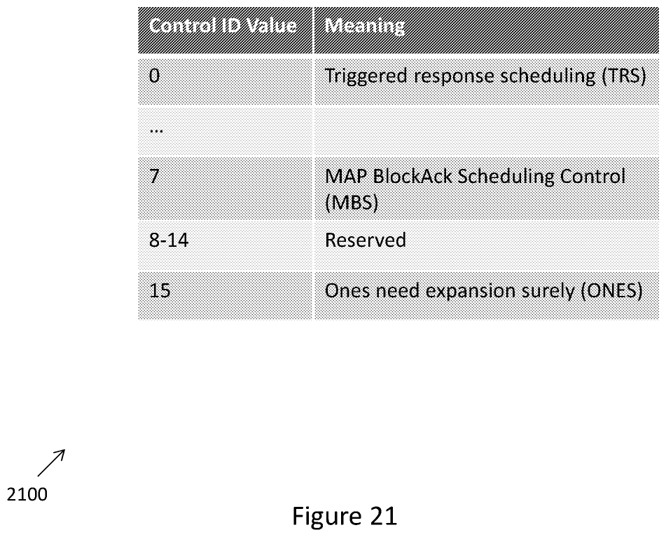

When BA Soliciting Manner subfield in the MAP Trigger frame is indicated as ‘TRS Control field or Trigger frame’, the Sharing AP and Shared AP(s) may indicate parameters of PPDU carrying BlockAck frame using a new Control subfield of the HE variant HT Control field to associated STAs. FIG. 20 illustrates a new A-Control subfield 2002 of a HE variant HT Control field format, and FIG. 21 illustrates an example table 2100 of Control ID subfield values with their corresponding explanations. For example, a Control ID subfield 2004 with a value of 7 indicates that the A-Control subfield 2002 is to be used for MAP BlockAck Scheduling Control (MBS).

The A-Control subfield 2002 may be 30 bits in length. The PPDU (i.e. transmitted from the Sharing AP and Shared AP(s) to their respective associated STAs) shall carry a BlockAck Request frame with a frame carrying the A-Control subfield 2002 to indicate parameters of BlockAck frame. The parameters of BlockAck frame may be indicated in Control Information subfield 2006 of the A-Control subfield 2002. The new control field may also be used in the case that BA frame is carried in a SU PPDU.

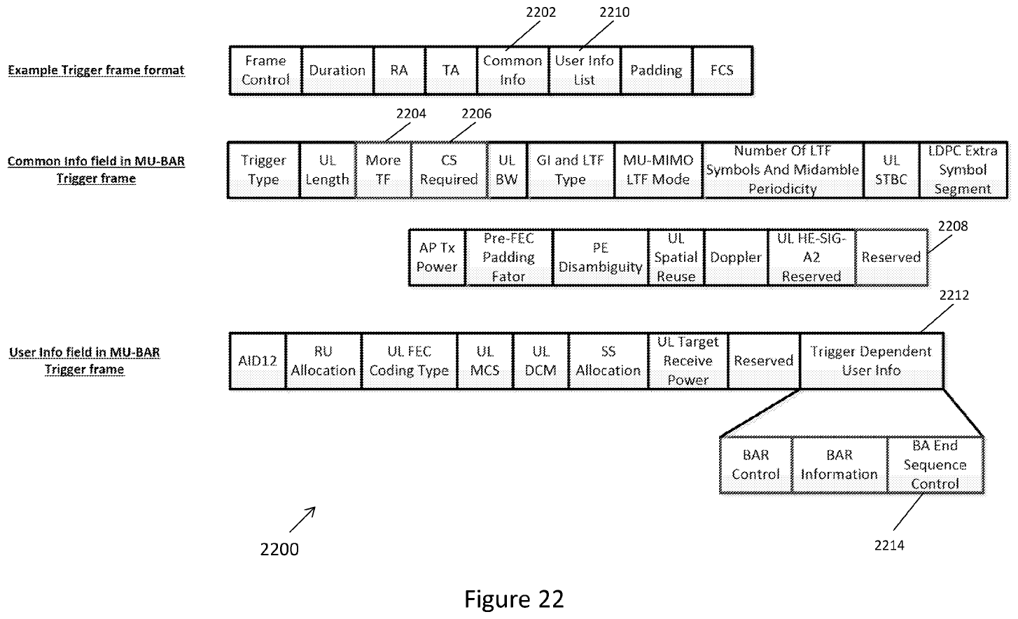

In an embodiment, the Sharing AP and Shared AP(s) may indicate parameters of PPDU carrying BlockAck frame by reusing a multi-user block acknowledgement request (MU-BAR) Trigger frame to associated STAs. FIG. 22 illustrates an example format of a MU-BAR Trigger frame 2200, which comprises at least a Common Information field 2202 and a User Info List field 2210. The Common Information field 2202 may comprise a More TF subfield 2204 and a CS Required subfield 2206. The More TF subfield 2204 may be used together with the CS Required subfield 2206 to indicate PPDU format of the PPDU carrying BlockAck frame. For example, the PPDU format may be indicated as a Non-HT PPDU, HE TB PPDU or EHT TB PPDU. The User Info List field 2210 may comprise a User Info field which includes at least a Trigger Dependent User Info subfield 2212. BA End Sequence Control subfield 2214 in the Trigger Dependent User Info subfield 2212 may be used to indicate size of BA. Reserved field 2208 may be used to indicate that the MU-BAR Trigger frame 2200 is reused to indicate parameters of PPDU carrying BA frame in C-OFDMA.

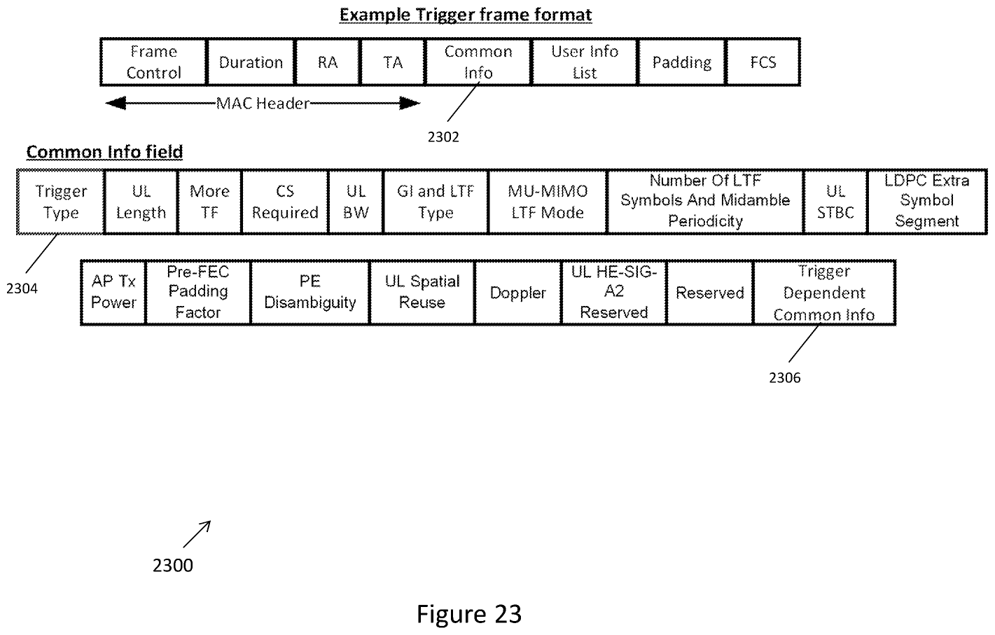

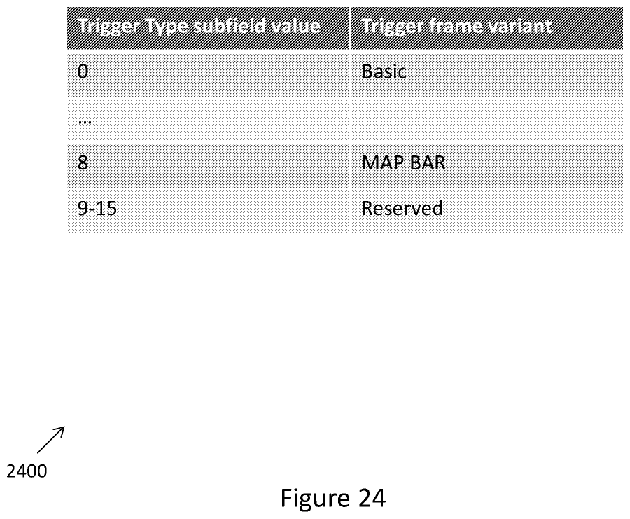

In an embodiment, the Sharing AP and Shared AP(s) may indicate parameters of PPDU carrying BlockAck frame in a Trigger frame variant which is carried in DL PPDU to associated STAs. FIG. 23 illustrates an example format of a new MAP-BAR Trigger frame 2300, which comprises at least a Common Information field 2302. The Common Information field 2302 may comprise at least a Trigger Type subfield 2304, a More TF field, a CS Required field, a MU-MIMO LTF Mode field, a UL STBC field, a LDPC Extra Symbol Segment field, a Doppler field, a UL-HE-SIGA2 Reserved field, and a Trigger Dependent Common Info field 2306. The Trigger Type subfield 2304 identifies the Trigger frame variant. Example of its encoding is defined in the table 2400 of FIG. 24. For example, a Trigger Type subfield value of 8 indicates that the trigger frame variant is a MAP BAR format.

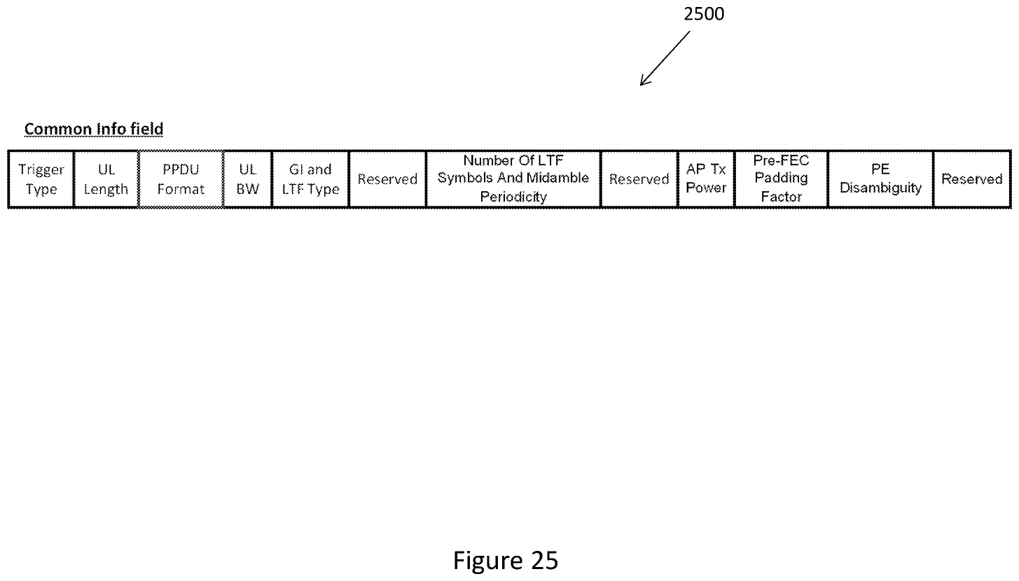

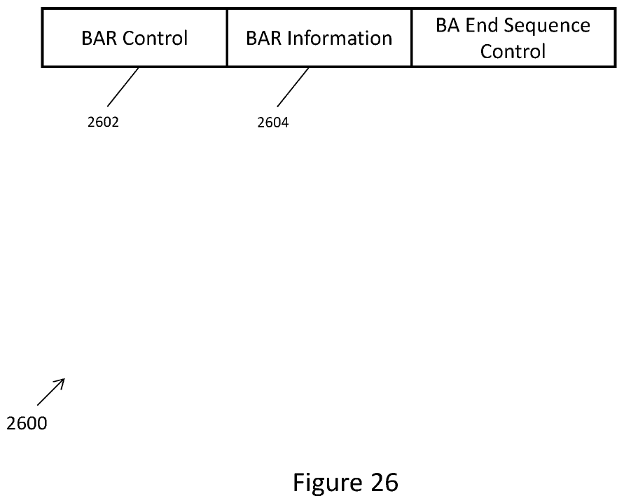

FIG. 25 illustrates an example of Common Information field 2500 of a MAP BAR Trigger frame format, wherein the More TF field, CS Required field, MU-MIMO LTF Mode field, UL STBC field, LDPC Extra Symbol Segment field, Doppler field and UL-HE-SIGA2 Reserved field in the Common Information field is reserved. Trigger Dependent User Info subfield 2600 of the MAP BAR Trigger frame 2300 is defined as shown in FIG. 26 (i.e. similar to the same subfield 2212 as the MU-BAR trigger frame 2200), wherein BAR Control subfield 2602 and BAR Information field 2604 is defined as in the BlockAck Request frame. While more information may be indicated in the MAP BAR Trigger frame as compared to the new A-Control subfield, bigger overhead of transmission may result.

In an embodiment, the Sharing AP may optionally solicit a MAP Response from Shared AP(s). The solicited MAP Response may carry the estimated parameters of expected BlockAck frame of the next round of C-OFDMA transmission and other negotiation information (i.e. empty buffer report) that the Sharing AP may need during the Coordinated phase. The MAP Response may be solicited by the MAP Trigger frame and transmitted in the end of a single round C-OFDMA transmission. The Sharing AP only solicits MAP Response when the following conditions are satisfied: the remaining TXOP permits, and next round of C-OFDMA transmission is a synchronous transmission.

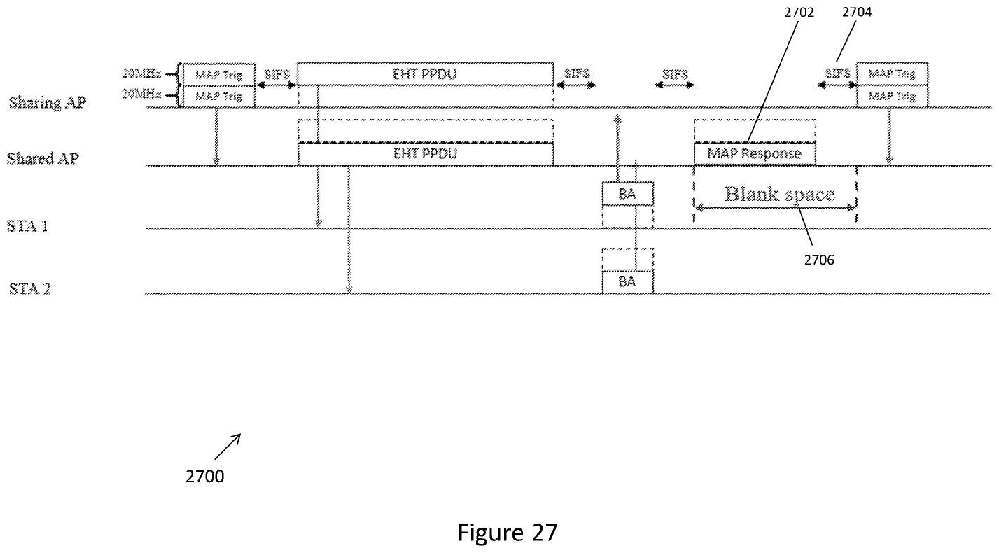

For a single round of C-OFDMA transmission, the Sharing AP indicates the parameters of PPDU carrying the BlockAck frame based on the parameters in MAP Response together with its own requirement in the MAP Trigger frame. The Shared AP(s) prepare and transmit its DL transmission subject to parameters indicated in both DL TXVECTOR field and UL TXVECTOR field. The Sharing AP and Shared AP(s) indicate parameters of PPDU carrying the BlockAck frame to associated STAs using TRS Control subfield of the HE variant HT Control field or a MU-BAR Trigger frame contained in the DL transmission. Advantageously, this ensures successful data transmission of Shared AP(s). Overhead of MAP Response is added in the C-OFDMA transmission procedure. Further, a ‘blank space’ is created for STAs associated with the Sharing AP. FIG. 27 illustrates an example flow diagram 2700 of the ‘blank space’. In flow diagram 2700, the STA1 cannot hear the Shared AP. The channel will be detected as idle in the duration of MAP Response 2702 and the following SIFS 2704 by STA1. This duration is a ‘blank space’ 2706 for STA1. If the STA1 tries to transmit something during this duration, collision may occur.

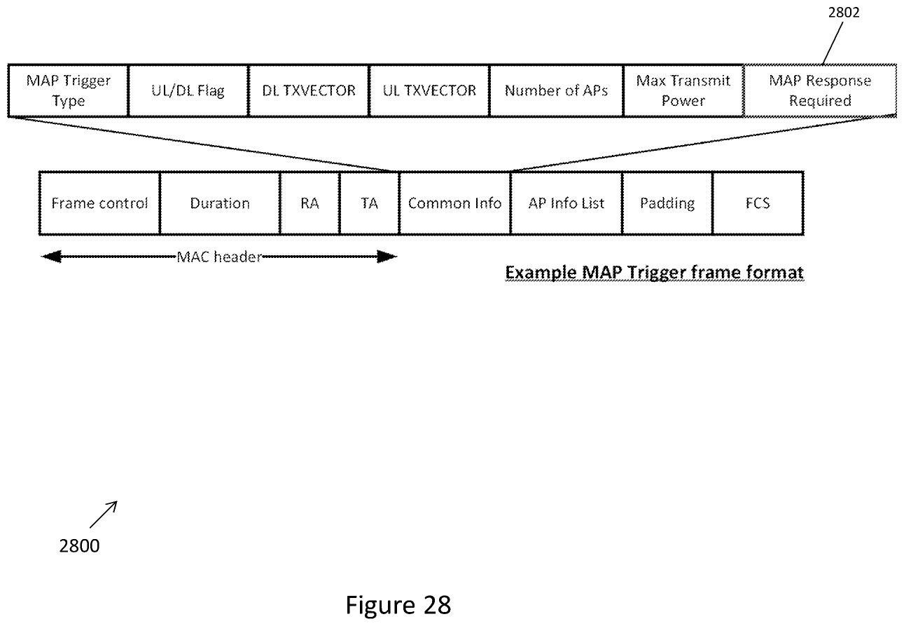

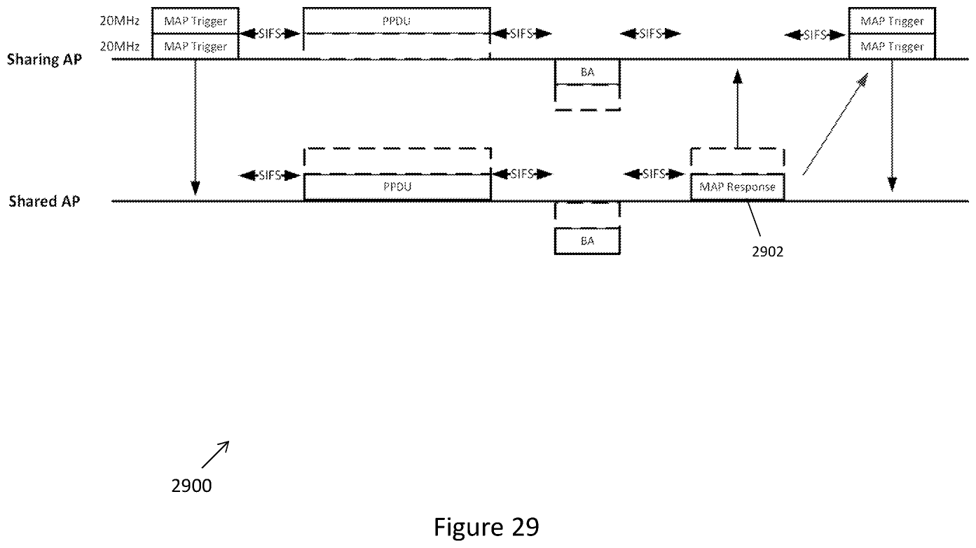

The Sharing AP may indicate whether a MAP Response is required from Shared AP(s) in MAP Trigger frame 2800 as shown in FIG. 28, by utilising a MAP Response Required subfield 2802. When a MAP Response is required, the procedure of a single round of C-OFDMA transmission is as shown in example flow diagram 2900 of FIG. 29. Shared AP(s) send a MAP Response 2902 to the Sharing AP at a SIFS after the received BlockAck frame.

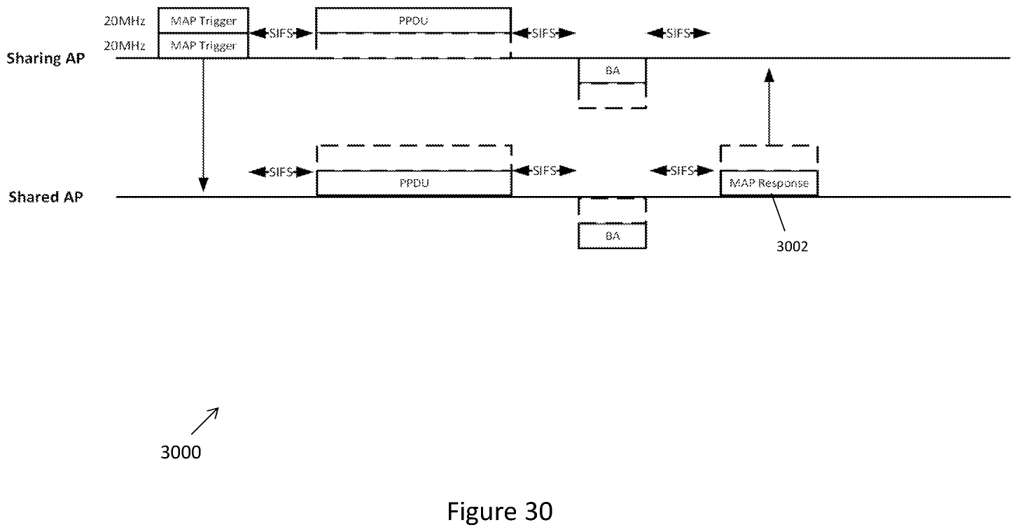

The MAP response may be carried in a MAC frame, as shown in MAP Response 3002 in example flow diagram 3000 of FIG. 30. For example, MAP Response 3002 may be an EHT PPDU carrying a MAP Response frame.

An example MAP Response frame format 3100 is illustrated in FIG. 3100. The parameters (e.g. PPDU length, number of EHT-LTF symbols, etc.) of PPDU carrying the MAP Response frame may be set as a predefined default parameters list, or alternatively, the necessary parameters may be indicated in the MAP Trigger frame.

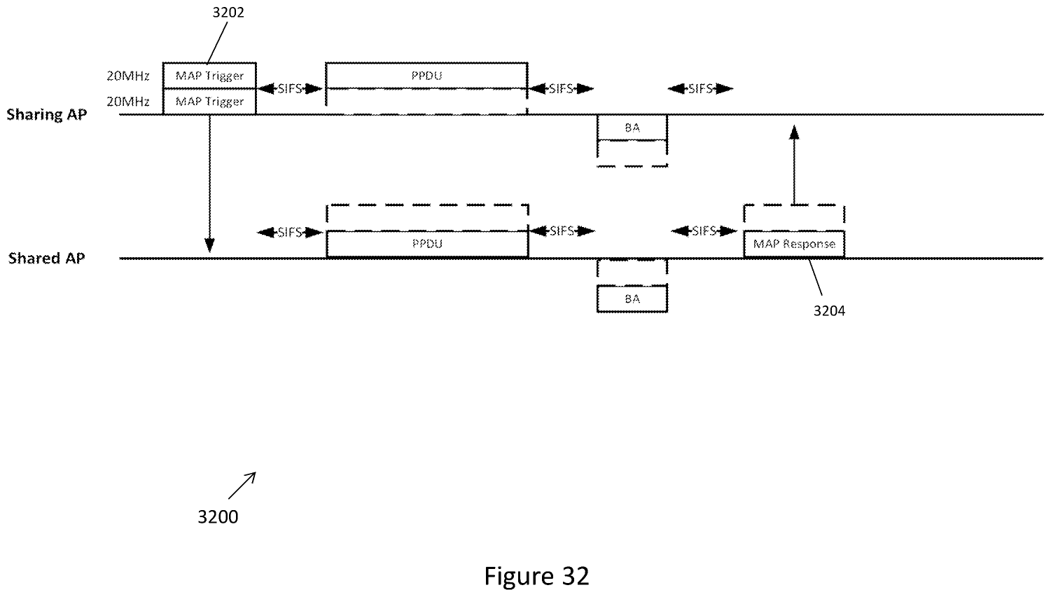

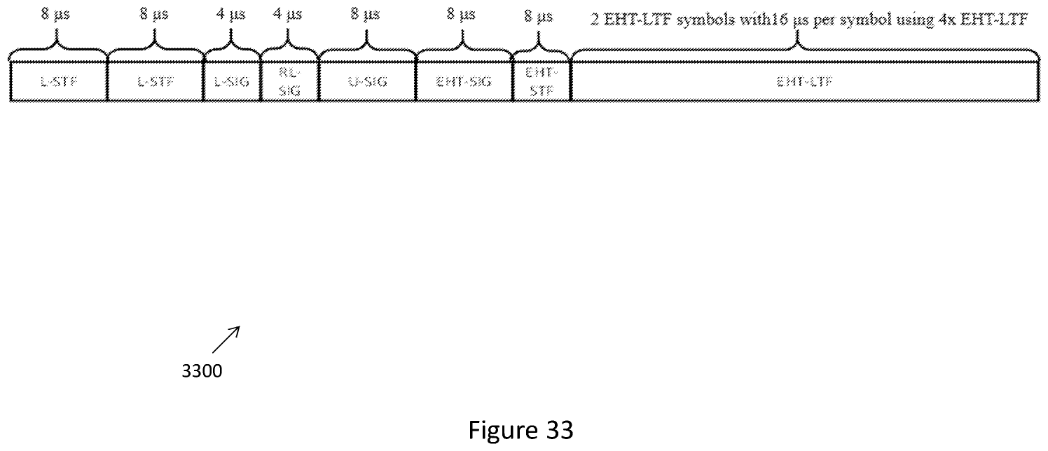

The information of MAP Response may be carried in a null data packet (NDP). As illustrated in example flow diagram 3200 of FIG. 32, MAP Response 3204 may be a MAP Response NDP. Some necessary information (i.e. Target RSSI) to solicit MAP Response NDP shall be indicated in Per AP Info subfield of AP Info List field in MAP Trigger frame 3202. An example format of a MAP Response NDP 3300 is illustrated in FIG. 33. Advantageously, lower overhead is achieved as compared to carrying MAP response in a MAC frame. However, STAs associated with Shared AP(s) may be unable to tell what the MAP Response NDP is for.

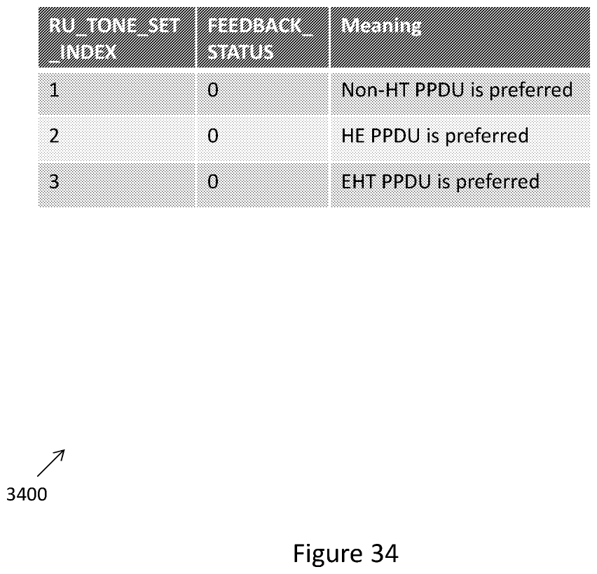

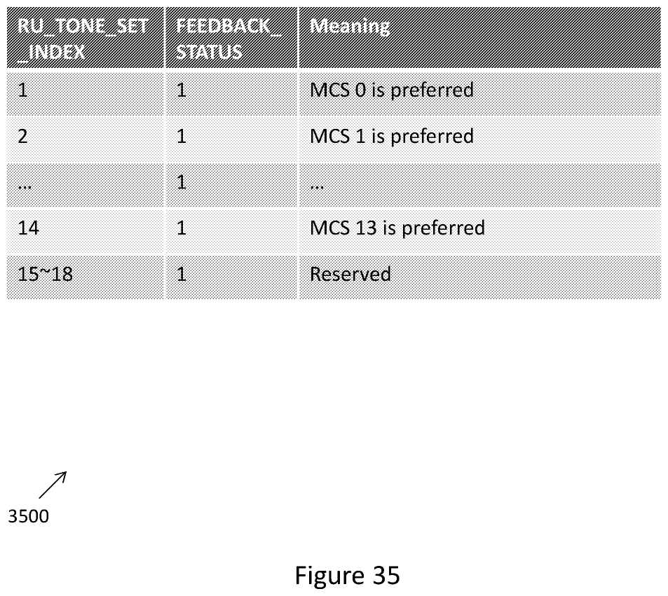

A scheduled Shared AP may use different tone sets to indicate preferred parameters using EHT-LTF field in MAP Response NDP. The tone set can be determined from FEEDBACK_STATUS (2 different status) and RU_TONE_SET_INDEX (18 different tone sets for each status), such that there are 36 entries in total for each 20 MHz channel. Preferred parameters need to be indicated, such as a preferred PPDU format, preferred MCS and preferred BA type. Referring to example table 3400 in FIG. 34, the preferred PPDU format may have 3 entries such as Non-HT PPDU (with RU tone set index of 1), HE PPDU (with RU tone set index of 2) and EHT PPDU (with RU tone set index of 3) when feedback status is ‘0’. Referring to example table 3500 in FIG. 35 where feedback status is ‘1’, there may be 0-13 entries for the preferred MCS with RU tone set index from 1-14. An AP may distinguish the MAP Response NDP from EHT TB feedback NDP (wherein only single RU tone set is used) by detecting whether multiple tone sets are used in EHT-LTF. Further, there may be 5 entries for the preferred BA type, such as Extended compressed/Compressed/Multi-Traffic Identifier (Multi-TID)/Groupcast with Retries (GCR)/General Link-GCR (GLK-GCR).

Available entries in MAP Response NDP may be used to indicate buffer status of the Shared AP(s). For example, if the Shared AP(s) indicates an empty buffer, the Sharing AP may terminate the coordination with the Shared AP(s) and re-allocate the corresponding subchannel(s) to itself or other Shared AP(s) In order to improve reliability, multiple entries may be aggregated to indicate the single preferred parameter. For example, RU_TONE_SET_INDEX 1+2+3 with FEEDBACK_STATUS 0 are used to indicate ‘Non-HT PPDU is preferred’.

The Sharing AP may allocate the subchannels which are used by itself to Shared AP(s) for the MAP Response transmission to reduce the ‘blank space’ for associated STAs. For example, the Shared AP(s) may transmit MAP Response on its own allocated subchannels as well as the extra allocated subchannel. The Sharing AP may allocate extra subchannels to Shared AP(s) based on the information (e.g. position, operating bandwidth) of associated STAs, wherein the extra subchannels are allocated only for the MAP Response transmission.

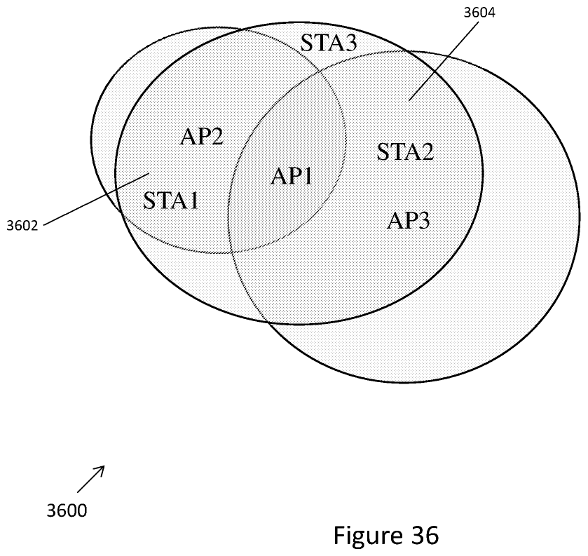

Referring to illustration 3600 of FIG. 36, an AP set includes one Sharing AP (AP1) and two Shared APs (AP2, AP3). AP1 obtains TXOP on an 80 MHz channel and allocates 3^{rd} & 4^{th} 20 MHz subchannels to AP2 and AP3, respectively. AP1 is associated with 3 STAs, STA1&STA3 operating in 40 MHz, and STA2 operating in 20 MHz. As shown in overlapping areas 3602 and 3604, STA1 is in the reachable range of AP2, and STA2 is in the reachable range of AP3 respectively. AP1 allocates the primary 20 MHz to AP3, as well as another 20 MHz to AP2 to transmit MAP Response. In this case, the ‘blank space’ for STA1 and STA2 is avoided.

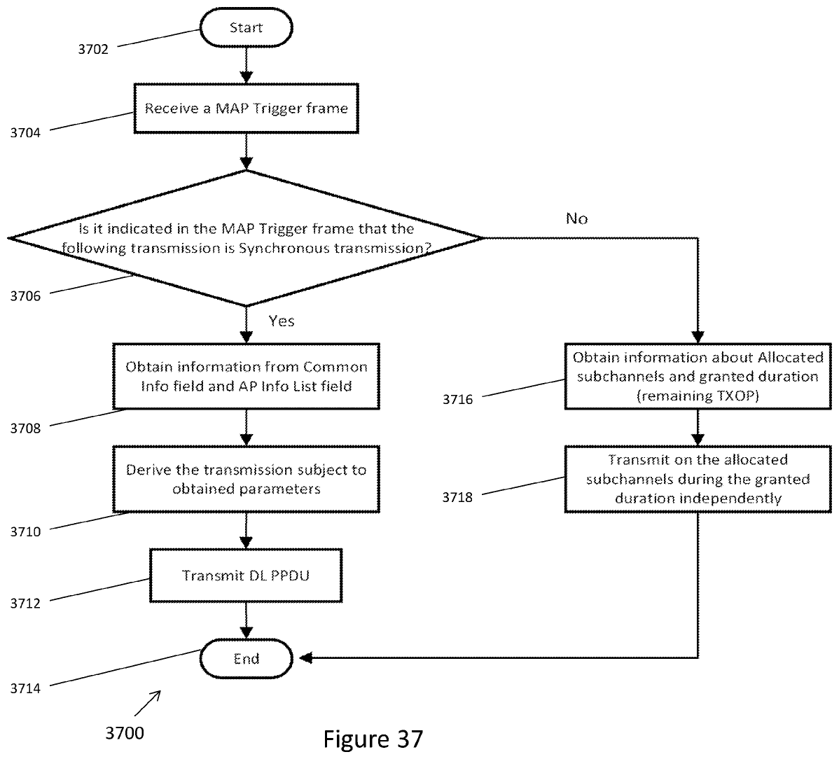

FIG. 37 illustrates a flowchart 3700 for shared AP behaviour. The process starts at step 3702. At step 3704, a MAP Trigger frame is received. At step 3706, it is determined whether it is indicated in the MAP Trigger frame that the following transmission is a synchronous transmission. If it is determined to be so, the process proceeds to step 3708 where information is obtained from Common Info field and AP Info List field of the MAP Trigger frame. At step 3710, the transmission is derived subject to the obtained parameters. At step 3712, a DL PPDU is transmitted, and then the process ends at step 3714. On the other hand, if it is determined at step 3706 that the following transmission is not a synchronous transmission i.e. it is an asynchronous transmission, the process proceeds to step 3716 where information about allocated subchannels and granted duration (i.e. remaining TXOP) is obtained. At step 3718, transmission occurs on the allocated subchannels during the granted duration independently. The process then ends at step 3714.

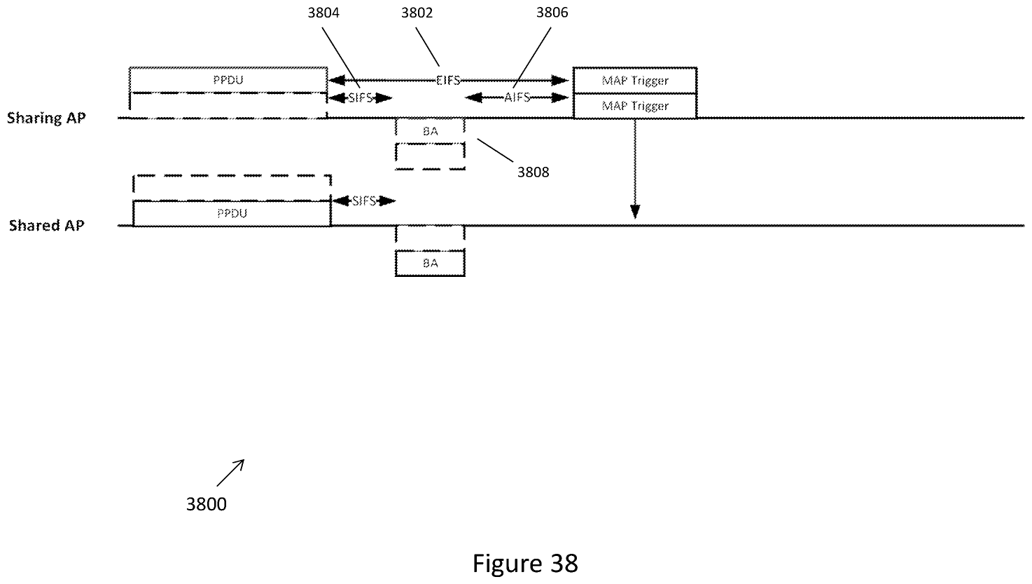

For C-OFDMA error recovery using an extended interframe space (EIFS), after transmitting MPDUs or A-MPDU that requires an Ack or BlockAck frame as a response, the Sharing AP shall wait for an AckTimeout interval, with a value of aSIFSTime+aSlotTime+aRxPHYStartDelay, starting at the PHY-TXEND.confirm primitive. If a PHY-RXSTART.indication primitive does not occur during the AckTimeout interval (i.e. no ACK/BlockAck frame is received), the Sharing AP commences transmission to Shared AP(s) at an EIFS after the previous transmission. The Sharing AP shall perform ED (Energy Detection) sensing during the EIFS and only commences transmission if the result of detection is idle. Referring to flow diagram 3800 of FIG. 38, EIFS 3802 may have a duration of the sum of aSIFSTime 3804+EstimatedAckTxTime+arbitration interframe space (AIFS) 3806, wherein the EstimatedAckTxTime is the expected duration of the PPDU 3808 carrying the BlockAck frame.

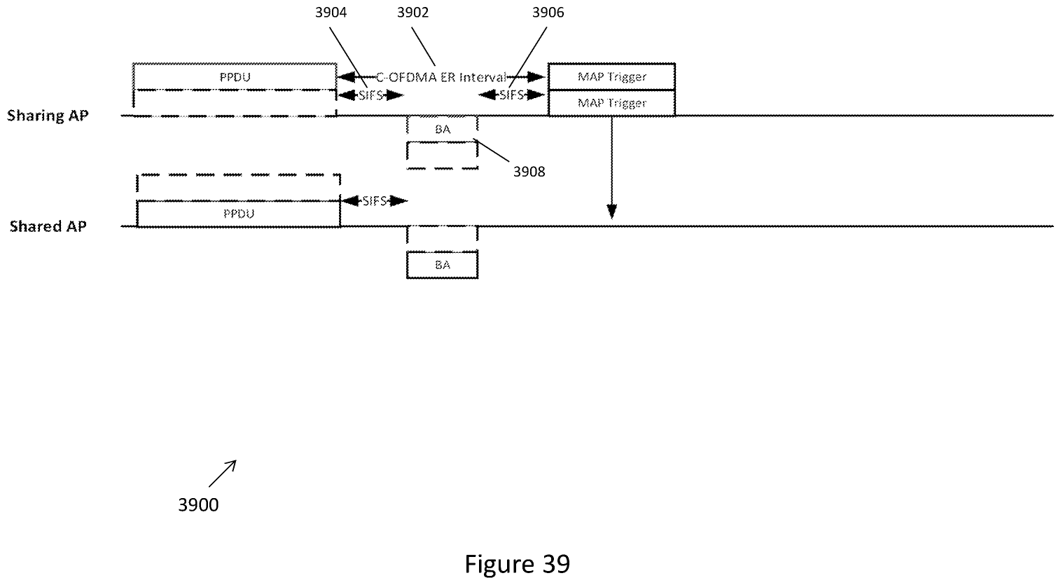

For C-OFDMA error recovery using a new C-OFDMA Error Recovery interval, after transmitting MPDUs or A-MPDU that requires an Ack or BlockAck frame as a response, the Sharing AP shall wait for an AckTimeout interval, with a value of aSIFSTime+aSlotTime+aRxPHYStartDelay, starting at the PHY-TXEND.confirm primitive. If a PHY-RXSTART.indication primitive does not occur during the AckTimeout interval (i.e. no ACK/BlockAck frame is received), the Sharing AP commences another transmission to Shared AP(s) at a C-OFDMA Error Recovery interval after the previous transmission. The Sharing AP shall perform ED (Energy Detection) sensing during the C-OFDMA Error Recovery and only commences transmission if the result of detection is idle. Referring to flow diagram 3900 of FIG. 39, C-OFDMA Error Recovery interval 3902 may have a duration of the sum of aSIFSTime 3904+EstimatedAckTxTime+aSIFSTime 3906, wherein the EstimatedAckTxTime is the expected duration of the PPDU 3908 carrying the BlockAck frame. If an erroneous BlockAck frame is received, the Sharing AP performs error recovery following the PIFS recovery mechanism. When transmission of BlockAck frame is aligned, no collision would be caused by PIFS recovery mechanism.

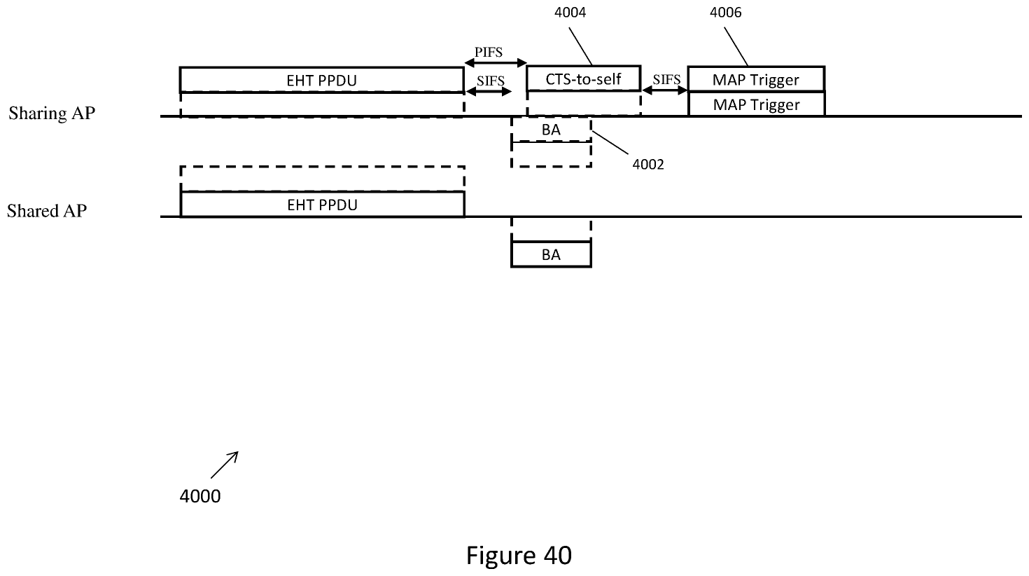

For C-OFDMA error recovery using transmission of short PPDUs, after transmitting MPDUs or A-MPDU that requires an Ack or BlockAck frame as a response, the Sharing AP shall wait for an AckTimeout interval, with a value of aSIFSTime+aSlotTime+aRxPHYStartDelay, starting at the PHY-TXEND.confirm primitive. Referring to flow diagram 4000 of FIG. 40, if a PHY-RXSTART.indication primitive does not occur during the AckTimeout interval (i.e. no ACK/BlockAck frame such as BA 4002 is received), the Sharing AP sends one or more short PPDUs 4004 (e.g. RTS frame, CTS-to-self frame) to associated STAs or to itself at a PIFS after the previous transmission. The Sharing AP commences another transmission (i.e. starting with MAP Trigger frame 4006) to Shared AP(s) at a SIFS after the short PPDUs (e.g. RTS and CTS exchange, multiple CTS-to-self frames), to ensure the duration of short PPDUs 4004 exceed duration of the expected BlockAck frame 4002.

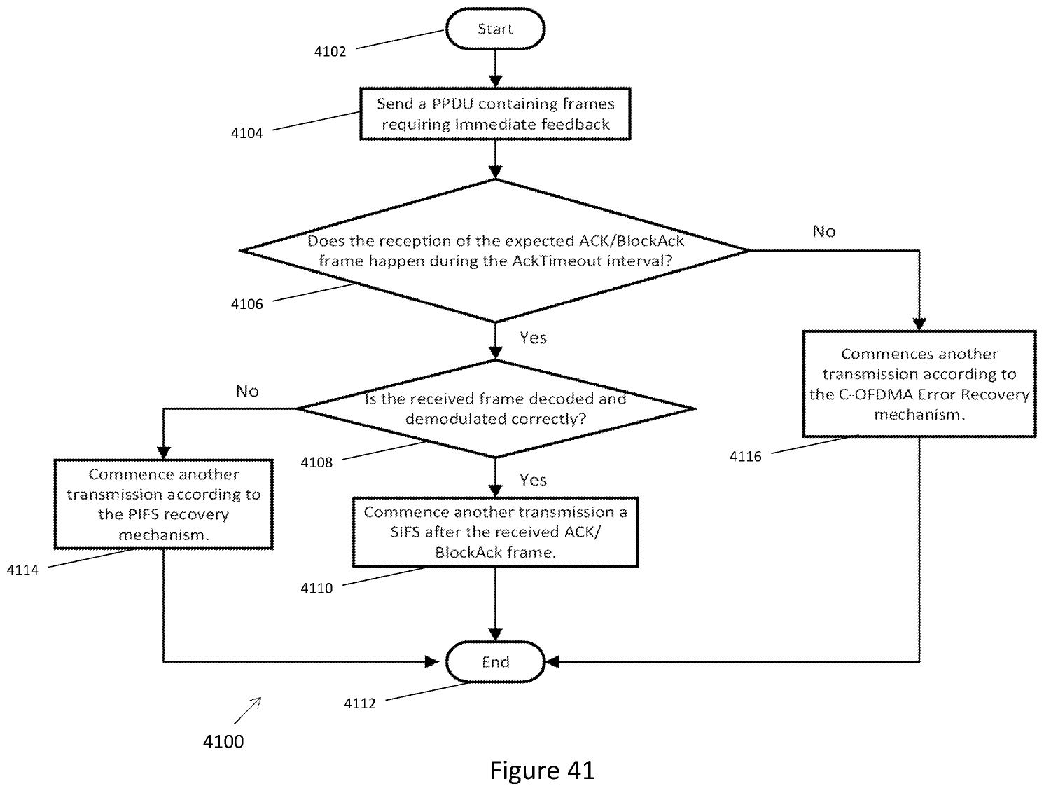

FIG. 41 illustrates a flowchart 4100 for sharing AP behaviour in error recovery. The process starts at step 4102. At step 4104, a PPDU is sent containing frames requiring immediate feedback. At step 4106, it is determined whether reception of an expected ACK/BlockAck frame happen during the AckTimeout interval. If it is determined to be the case, the process then proceeds to step 4108 where it is determined whether the received frame is decoded and demodulated correctly. If it is determined to be the case, the process proceeds to step 4110 where another transmission is commenced at a SIFS after the received ACK/BlockAck frame, and then the process ends at step 4112. Otherwise, the process proceeds instead to step 4114 where another transmission is commenced according to PIFS recovery mechanism, before the process ends at step 4112. On the other hand, if it is determined at step 4106 that reception of the expected ACK/BlockAck frame did not occur during the AckTimeout interval, the process proceeds to step 4116 instead, where another transmission is commenced according to C-OFDMA Error Recovery mechanism i.e. as shown in the examples of FIGS. 38, 39 and 40, before the process ends at step 4112.

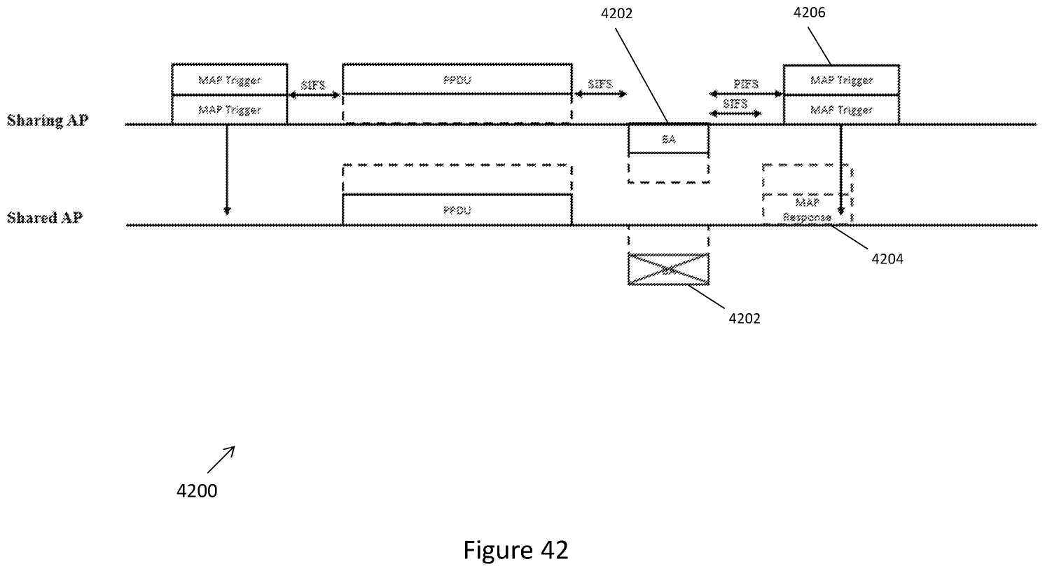

Referring to flow diagram 4200 of FIG. 42 for C-OFDMA Error Recovery in the case where MAP response is required and the expected ACK/BlockAck frame is received, the Shared AP(s) may transmit a MAP Response 4204 at a SIFS after end of a received ACK/BlockAck frame 4202. If the expected ACK/BlockAck frame 4202 is not received, the Shared AP(s) transmit a MAP Response 4204 at a SIFS after the expected end of the ACK/BlockAck frame 4202. If the received ACK/BlockAck frame 4202 is recognized as invalid, the Shared AP(s) does not transmit the subsequent MAP Response 4204. If the expected ACK/BlockAck frame 4202 is received during the AckTimeout interval, whether the ACK/BlockAck frame 4202 is decoded successfully or not, the Sharing AP shall wait for an AckTimeout interval starting at the PHY-RXEND.confirm primitive. If a PHY-RXSTART.indication primitive does not occur during the AckTimeout interval (i.e. no MAP Response 4204 is received), the Sharing AP commences transmission to Shared AP(s) at a PIFS after the end of BlockAck frame 4202 i.e. starting with MAP Trigger frame 4206.

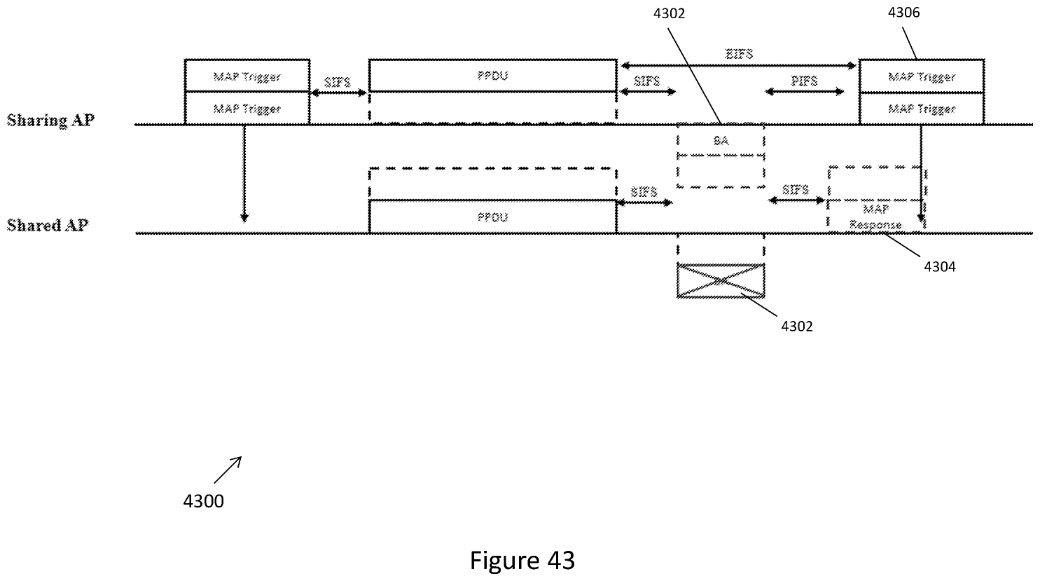

Referring to flow diagram 4300 of FIG. 43 for C-OFDMA Error Recovery in the case where MAP response is required and an expected ACK/BlockAck frame 4302 is not received during the AckTimeout interval, the Sharing AP shall wait for an AckTimeout interval after the estimated end of the ACK/BlockAck frame 4302. If a PHY-RXSTART.indication primitive does not occur during the AckTimeout interval (i.e. no MAP Response 4304 is received), the Sharing AP may commence transmission to Shared AP(s) (i.e. starting with MAP Trigger frame 4306) either at an EIFS after the previous transmission (such that the shortest EIFS=aSIFSTime+EstimatedAckTxTime+PIFS), or at a PIFS after the estimated end of the ACK/BlockAck frame. To reduce the complexity, the corruption of a MAP Response would not cause any error recovery procedure.

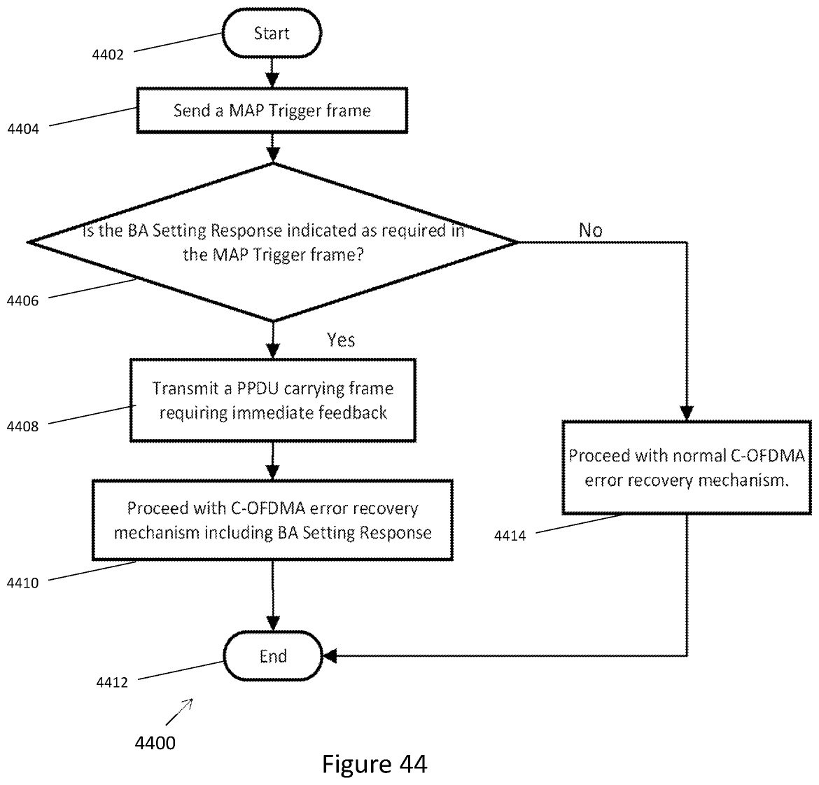

FIG. 44 illustrates a flowchart 4400 for sharing AP behaviour in C-OFDMA error recovery. The process starts at step 4402. At step 4404, a MAP Trigger frame is sent. At step 4406, it is determined whether MAP Response is indicated as required in the MAP Trigger frame. If it is determined to be the case, the process then proceeds to step 4408 where a PPDU carrying frame requiring immediate feedback is transmitted. At step 4410, C-OFDMA error recovery mechanism including MAP Response proceeds. The process then ends at step 4412. On the other hand, if it is determined at step 4406 that MAP Response is not indicated as required in the MAP Trigger frame, the process proceeds to step 4114 instead, where normal C-OFDMA error recovery mechanism proceeds, before the process ends at step 4412.

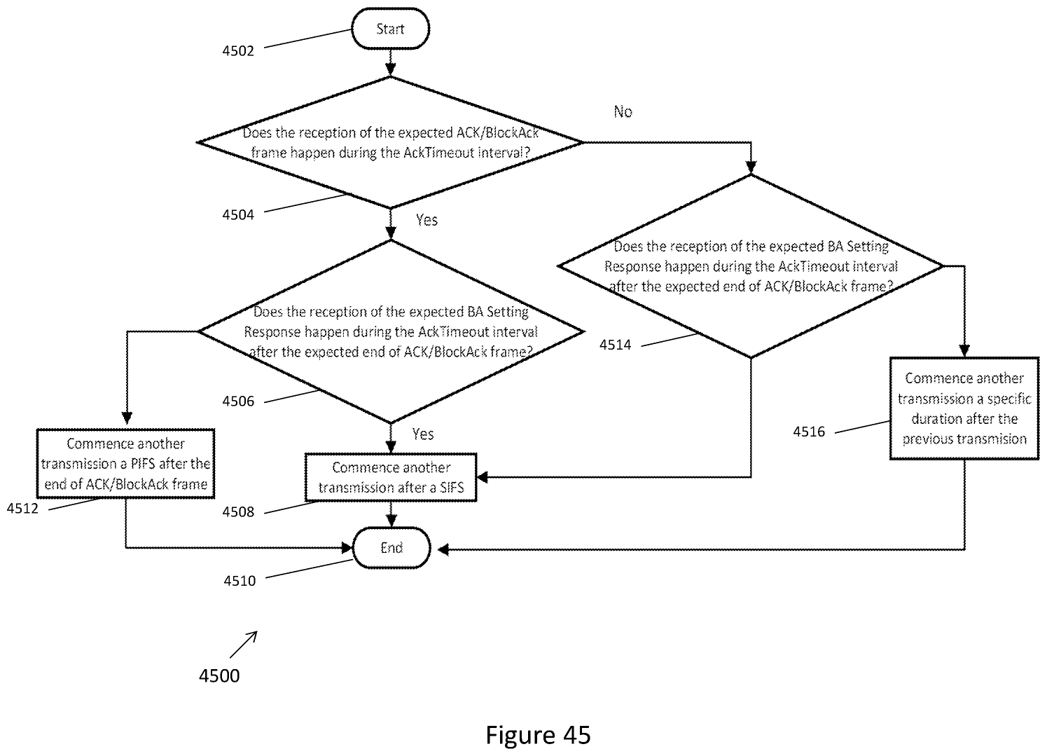

FIG. 45 illustrates a flowchart 4500 for sharing AP behaviour in C-OFDMA error recovery mechanism including MAP Response. The process starts at step 4502. At step 4504, it is determined whether reception of an expected ACK/BlockAck frame happen during the AckTimeout interval. If it is determined to be the case, the process then proceeds to step 4506, where it is determined whether reception of an expected MAP Response happen during the AckTimeout interval after the expected end of ACK/BlockAck frame. If it is determined to be the case, the process then proceeds to step 4508 where another transmission after a SIFS is commenced, before the process ends at step 4510. Otherwise, the process proceeds from step 4506 to step 4512 instead, where another transmission is commenced at a PIFS after the end of the ACK/BlockAck frame, and ends at step 4510. On the other hand, if it is determined at step 4504 that reception of an expected ACK/BlockAck frame did not occur during the AckTimeout interval, the process proceeds to step 4514 instead, where it is determined whether reception of an expected MAP Response happen during the AckTimeout interval after the expected end of ACK/BlockAck frame. If it is determined to be the case, the process proceeds to step 4508 where another transmission is commenced after a SIFS, and then the process ends at step 4510. Otherwise, the process proceeds from step 4514 to step 4516 instead, where another transmission is commenced at a specific duration after the previous transmission, before the process ends at step 4510.

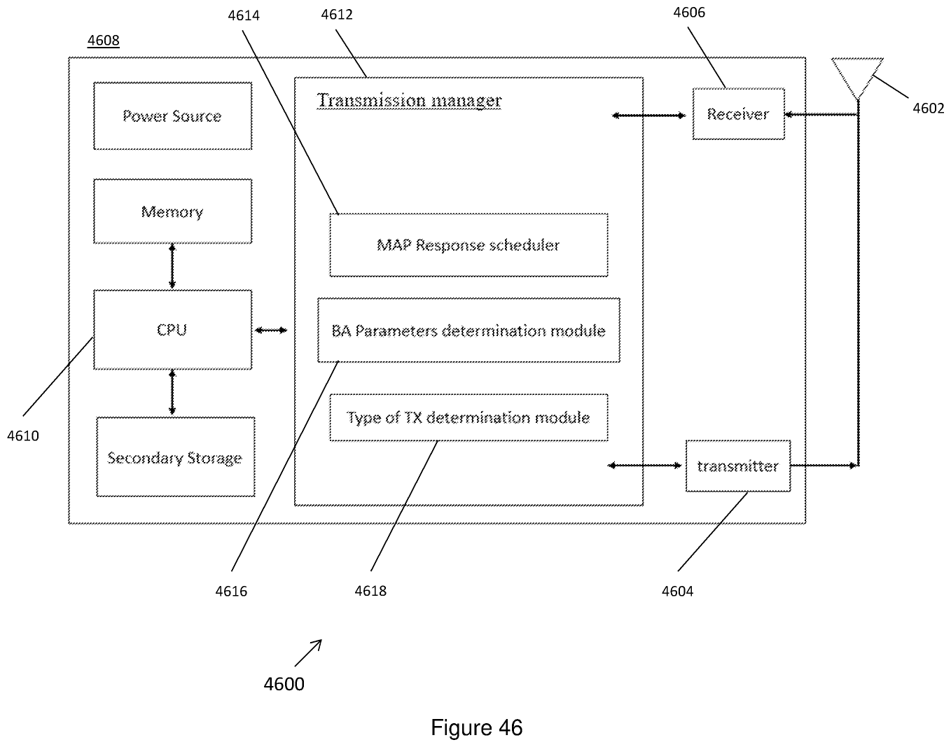

FIG. 46 shows a configuration of a communication device 4600, for example a communication apparatus, for example a Sharing AP, according to various embodiments. The communication apparatus 4600 in the schematic example of FIG. 46 includes at least one antenna 4602 with at least one radio transmitter 4604, at least one radio receiver 4606 and circuitry 4608. The circuitry 4608 may include at least one controller or CPU 4610 for use in software and hardware aided execution of tasks the CPU 4610 is designed to perform, including control of communication with other communication apparatuses such as an associated STA, or another AP such as a Shared AP.

The circuitry 4608 may further include a transmission manager 4612 which is responsible for transmission processes of the communication device 4600. The transmission manager 4612 may comprise a MAP Response scheduler 4614 for scheduling MAP responses, a BA Parameters determination module 4616 for determining BA parameters, and a Transmission Type determination module 4618 for determining transmission type.

The PPDU transmitted by APs to STAs may only include partial parameters which are necessary. Such necessary parameters include format of PPDU, length of PPDU, AP Tx Power, Target RSSI, and other similar parameters. Other parameters of PPDU carrying the BlockAck frame may be decided by the STA itself subject to the parameters that are indicated, such as MCS, data rate, and other similar parameters. To ensure alignment, some parameters such like number of LTF symbols may be decided by a unified predefined list.

The PPDU transmitted by APs to STAs may only include partial parameters which is necessary, while other parameters of BlockAck frame may be decided by STA itself subject to the parameters that are indicated. For example, some necessary parameters may include type of BlockAck, maximal bitmap size, and other similar parameters. Parameters that may be decided by STA may include bitmap size and other similar parameters.

Further, a STA receiving a new A-Control field/a new Trigger frame or a new MAC feature soliciting BlockAck with partial parameters for PPDU carrying the BlockAck frame or the BlockAck frame, may decide other parameters of PPDU carrying the BlockAck frame or of BlockAck frame by itself subject to the indicated parameters.

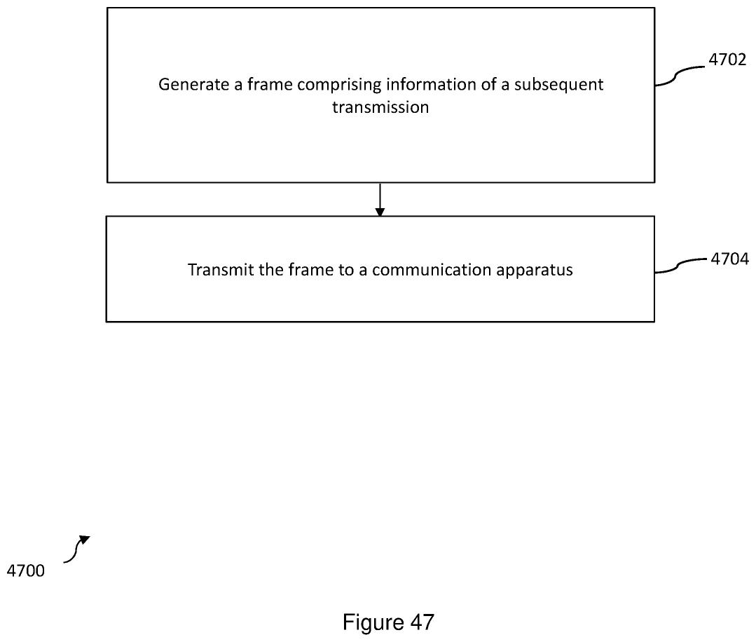

FIG. 47 shows a flow diagram 4700 illustrating a communication method according to various embodiments. At step 4702, a frame is generated comprising information of a subsequent transmission. At step 4704, the frame is transmitted to a communication apparatus.

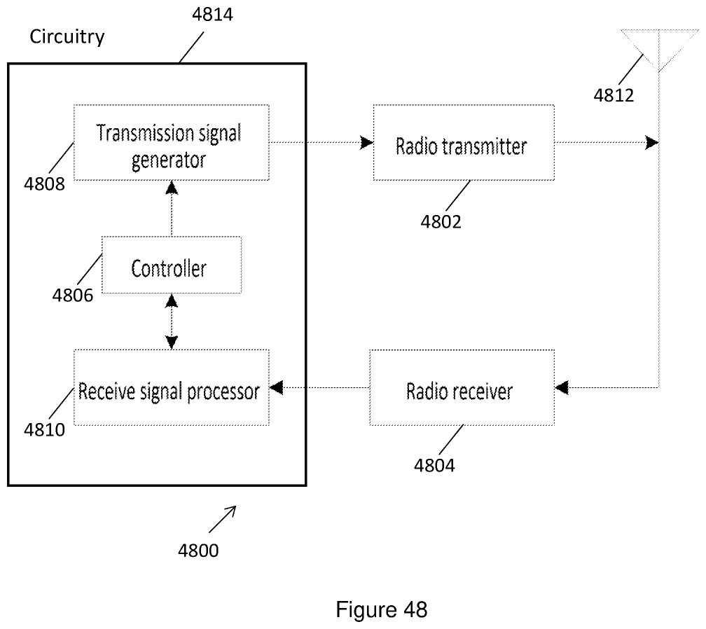

FIG. 48 shows a schematic, partially sectioned view of a communication apparatus 4800 that can be implemented for Multi-AP synchronous transmission. The communication apparatus 4800 may be implemented as a Sharing AP, Shared AP or an associated STA according to various embodiments.

Various functions and operations of the communication apparatus 4800 are arranged into layers in accordance with a hierarchical model. In the model, lower layers report to higher layers and receive instructions therefrom in accordance with IEEE specifications. For the sake of simplicity, details of the hierarchical model are not discussed in the present disclosure.

As shown in FIG. 48, the communication apparatus 4800 may include circuitry 4814, at least one radio transmitter 4802, at least one radio receiver 4804 and multiple antennas 4812 (for the sake of simplicity, only one antenna is depicted in FIG. 48 for illustration purposes). The circuitry may include at least one controller 4806 for use in software and hardware aided execution of tasks it is designed to perform, including control of communications with one or more other multi-link devices in a MIMO wireless network. The at least one controller 4806 may control at least one transmission signal generator 4808 for generating frames to be sent through the at least one radio transmitter 4802 to one or more other STAs, APs or multi-link devices (MLDs) and at least one receive signal processor 4810 for processing frames received through the at least one radio receiver 4804 from the one or more other STAs, APs or MLDs. The at least one transmission signal generator 4808 and the at least one receive signal processor 4810 may be stand-alone modules of the communication apparatus 4800 that communicate with the at least one controller 4806 for the above-mentioned functions. Alternatively, the at least one transmission signal generator 4808 and the at least one receive signal processor 4810 may be included in the at least one controller 4806. It is appreciable to those skilled in the art that the arrangement of these functional modules is flexible and may vary depending on the practical needs and/or requirements. The data processing, storage and other relevant control apparatus can be provided on an appropriate circuit board and/or in chipsets.

In various embodiments, when in operation, the at least one radio transmitter 4802, at least one radio receiver 4804, and at least one antenna 4812 may be controlled by the at least one controller 4806. Furthermore, while only one radio transmitter 4802 is shown, it will be appreciated that there can be more than one of such transmitters.

In various embodiments, when in operation, the at least one radio receiver 4804, together with the at least one receive signal processor 4810, forms a receiver of the communication apparatus 4800. The receiver of the communication apparatus 4800, when in operation, provides functions required for multi-link communication. While only one radio receiver 4804 is shown, it will be appreciated that there can be more than one of such receivers.

The communication apparatus 4800, when in operation, provides functions required for Multi-AP synchronous transmission. For example, the communication apparatus 4800 may be a Sharing AP. The circuitry 4814 may, in operation, generate a frame comprising information of a subsequent transmission. The transmitter 4802 may, in operation, transmit the frame the frame to another communication apparatus.

The communication apparatus 4800 and the another communication apparatus may be APs. The information may indicate whether the subsequent transmission is asynchronous or synchronous. The information may indicate parameters of a PPDU carrying BlockAck frame for the subsequent transmission. The circuitry 4814 may be further configured to determine the parameters based on a maximal length of bitmap in a BlockAck frame.

The information may further indicate that the subsequent transmission is a downlink (DL) transmission, wherein the transmitter 4802 may be configured to transmit data to an associated STA based on the information, and wherein the receiver 4804 may, in operation, receive a PPDU carrying BlockAck frame from the associated STA based on the parameters after transmitting the data.

The information may further indicate that the subsequent transmission is a UL transmission, wherein the receiver 4804 may, in operation, receive data from an associated STA based on the information, and wherein the transmitter 4802 may be configured to transmit a PPDU carrying BlockAck frame to the associated STA based on the parameters after receiving the data.

The frame may be a MAP trigger frame, and when a BA Soliciting Manner subfield in the MAP trigger frame is indicated as ‘TRS Control field or Trigger frame’, the transmitter may be configured to transmit a frame carrying a TRS Control subfield or a MBS Control subfield to indicate parameters of BlockAck frame to an associated STA.

The transmitter 4802 may be configured to transmit a MU-BAR Trigger frame or MAP-BAR trigger frame to indicate parameters of PPDU carrying BlockAck frame to an associated STA.

The frame may be a MAP trigger frame, the MAP Trigger frame comprising a request for a MAP response from the another communication apparatus; wherein the receiver 4804 may, in operation, receive the MAP response from the another communication apparatus, wherein the MAP response comprises estimated parameters of an expected BlockAck frame for the subsequent transmission. The transmitter 4802 may be configured to transmit another MAP Trigger frame indicating parameters of PPDU carrying BlockAck frame to the another communication apparatus, such that the parameters are determined based on the estimated parameters in the MAP response; and wherein the transmitter 4802 may be further configured to transmit data to an associated STA, such that the data indicates parameters of PPDU carrying BlockAck frame. When an expected ACK or BlockAck frame is received within an AckTimeout interval after a previous transmission, and when no MAP response is received during another AckTimeout interval starting at a PHY-RXEND.confirm primitive, the transmitter 4802 may be configured to commence another transmission to the another communication apparatus at a PIFS after the end of the received ACK or BlockAck frame. When an expected ACK or BlockAck frame is not received within an AckTimeout interval after a previous transmission, and when no MAP response is received during another AckTimeout interval after an estimated end of the expected ACK or BlockAck frame, the transmitter 4802 may be configured to commence another transmission to the another communication apparatus at a PIFS after the end of the received ACK or BlockAck frame, or at a EIFS after the previous transmission.

The transmitter 4802 may be configured to transmit a MPDU or A-MPDU that requires an Ack or BlockAck frame as a response, and wherein the transmitter 4802 may be further configured to commence another transmission to the another communication apparatus at a time duration after transmission of the MPDU or A-MPDU, when no ACK or BlockAck frame is received within an AckTimeout interval after transmission of the MPDU or A-MPDU. The time duration may be an extended interframe space (EIFS)=a SIFS time+EstimatedAckTxTime+AIFS, or a C-OFDMA Error Recovery interval=aSIFSTime+EstimatedAckTxTime+aSIFSTime, wherein the EstimatedAckTxTime is an expected duration of a PPDU carrying BlockAck frame. The transmitter 4802 may be further configured to transmit one or more short PPDUs to an associated STA or back to the communication apparatus at a PIFS after the transmission of the MPDU or A-MPDU, wherein the another transmission is commenced at a SIFS after the transmission of the one or more short PPDUs.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication device.

Some non-limiting examples of such communication device include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication device is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication device may comprise an apparatus such as a controller or a sensor which is coupled to a communication apparatus performing a function of communication described in the present disclosure. For example, the communication device may comprise a controller or a sensor that generates control signals or data signals which are used by a communication apparatus performing a communication function of the communication device.

The communication device also may include an infrastructure facility, such as a base station, an access point, and any other apparatus, device or system that communicates with or controls apparatuses such as those in the above non-limiting examples.

A non-limiting example of a station may be one included in a first plurality of stations affiliated with a multi-link station logical entity (i.e. such as an MLD), wherein as a part of the first plurality of stations affiliated with the multi-link station logical entity, stations of the first plurality of stations share a common medium access control (MAC) data service interface to an upper layer, wherein the common MAC data service interface is associated with a common MAC address or a Traffic Identifier (TID).

Thus, it can be seen that the present embodiments provide communication devices and methods for Multi-AP synchronous transmission.

While exemplary embodiments have been presented in the foregoing detailed description of the present embodiments, it should be appreciated that a vast number of variations exist. It should further be appreciated that the exemplary embodiments are examples, and are not intended to limit the scope, applicability, operation, or configuration of this disclosure in any way. Rather, the foregoing detailed description will provide those skilled in the art with a convenient road map for implementing exemplary embodiments, it being understood that various changes may be made in the function and arrangement of steps and method of operation described in the exemplary embodiments and modules and structures of devices described in the exemplary embodiments without departing from the scope of the subject matter as set forth in the appended claims.

1. A communication apparatus, comprising:
circuitry, which in operation, generates a frame comprising information of a subsequent transmission; and
a transmitter, which in operation, transmits the frame to another communication apparatus.

2. The communication apparatus according to claim 1, wherein the communication apparatus and the another communication apparatus are access points (APs).

3. The communication apparatus according to claim 1, wherein the information indicates whether the subsequent transmission is asynchronous or synchronous.

4. The communication apparatus according to claim 1, wherein the information indicates parameters of a physical layer protocol data unit (PPDU) carrying block acknowledgement (BlockAck) frame for the subsequent transmission.

5. The communication apparatus according to claim 4, wherein the circuitry is configured to determine the parameters based on a maximal length of bitmap in a BlockAck frame.

6. The communication apparatus according to claim 4, wherein the information further indicates that the subsequent transmission is a downlink (DL) transmission, wherein the transmitter is configured to transmit data to an associated STA based on the information, and wherein the communication apparatus further comprises a receiver, which in operation, receives a PPDU carrying BlockAck frame from the associated STA based on the parameters after transmitting the data.

7. The communication apparatus according to claim 4, wherein the information further indicates that the subsequent transmission is a uplink (UL) transmission, wherein the communication apparatus further comprises a receiver, which in operation, receives data from an associated STA based on the information, and wherein the transmitter is configured to transmit a PPDU carrying BlockAck frame to the associated STA based on the parameters after receiving the data.

8. The communication apparatus according to claim 1, wherein the frame is a MAP trigger frame, and when a BA Soliciting Manner subfield in the MAP trigger frame is indicated as ‘triggered response scheduling (TRS) Control field or Trigger frame’, the transmitter may be configured to transmit a frame carrying a TRS Control subfield or a MAP BlockAck Scheduling (MBS) Control subfield to indicate parameters of BlockAck frame to an associated STA.

9. The communication apparatus according to claim 1, wherein the transmitter is configured to transmit a multi-user block acknowledgement request (MU-BAR) Trigger frame or MAP-BAR trigger frame to indicate parameters of PPDU carrying BlockAck frame to an associated STA.

10. The communication apparatus according to claim 1, wherein the frame is a MAP trigger frame, the MAP Trigger frame comprising a request for a MAP response from the another communication apparatus; wherein the communication apparatus further comprises a receiver, which in operation, receives the MAP response from the another communication apparatus, wherein the MAP response comprises estimated parameters of an expected BlockAck frame for the subsequent transmission.

11. The communication apparatus according to claim 10, wherein the transmitter is configured to transmit another MAP Trigger frame indicating parameters of PPDU carrying BlockAck frame to the another communication apparatus, such that the parameters are determined based on the estimated parameters in the MAP response; and wherein the transmitter is further configured to transmit data to an associated STA, such that the data indicates parameters of PPDU carrying BlockAck frame.

12. The communication apparatus according to claim 1, wherein the transmitter is configured to transmit a MAC protocol data unit (MPDU) or aggregated-MPDU (A-MPDU) that requires an Ack or BlockAck frame as a response, and wherein the transmitter is further configured to commence another transmission to the another communication apparatus at a time duration after transmission of the MPDU or A-MPDU, when no ACK or BlockAck frame is received within an AckTimeout interval after transmission of the MPDU or A-MPDU.

13. The communication apparatus according to claim 12, wherein the time duration is an extended interframe space (EIFS)=a short interframe space (SIFS) time+EstimatedAckTxTime+arbitration interframe space (AIFS), or a coordinated Orthogonal Frequency Division Multiple Access (C-OFDMA) Error Recovery interval=aSIFSTime+EstimatedAckTxTime+aSIFSTime, wherein the EstimatedAckTxTime is an expected duration of a PPDU carrying BlockAck frame.

14. The communication apparatus according to claim 12, wherein the transmitter is further configured to transmit one or more short PPDUs to an associated STA or back to the communication apparatus at a Priority Interframe Space (PIFS) after the transmission of the MPDU or A-MPDU, wherein the another transmission is commenced at a SIFS after the transmission of the one or more short PPDUs.

15. The communication apparatus according to claim 10, wherein when an expected ACK or BlockAck frame is received within an AckTimeout interval after a previous transmission, and when no MAP response is received during another AckTimeout interval starting at a PHY-RXEND.confirm primitive, the transmitter is configured to commence another transmission to the another communication apparatus at a PIFS after the end of the received ACK or BlockAck frame.

16. The communication apparatus according to claim 10, wherein when an expected ACK or BlockAck frame is not received within an AckTimeout interval after a previous transmission, and when no MAP response is received during another AckTimeout interval after an estimated end of the expected ACK or BlockAck frame, the transmitter is configured to commence another transmission to the another communication apparatus at a PIFS after the end of the received ACK or BlockAck frame, or at a EIFS after the previous transmission.

17. A communication method comprising:
generating a frame comprising information of a subsequent transmission; and
transmitting the frame to a communication apparatus.
